(19) United States
(12) Patent Application Publication
(10) Pub. No.: US 2026/0296872 A1
(43) Pub. Date: Oct. 1, 2026

(54) PORTABLE FLUID MANAGEMENT SYSTEM FOR CLEANING AND SHOWERING

(71) Applicant: Geyser Industries, Inc., Montrose, CO (US)

(72) Inventor: Jonathan Ballesteros, Montrose, CO (US)

(73) Assignee: Geyser Industries, Inc., Montrose, CO (US)

(21) Appl. No.: 19/090,241

(22) Filed: Mar. 25, 2025

Related U.S. Application Data
(60) Provisional application No. 63/569,374, filed on Mar. 25, 2024.

(51) Int. Cl. B67D 7/02

(52) U.S. Cl. CPC B67D 7/0288

(57) ABSTRACT

A portable, compact, battery-powered fluid management system including a continuous flow pump having an inlet for drawing in a fluid, such as water from a water bottle or other fluid supply and pumping the fluid out through an outlet in a continuous, non-pulsatile manner. There is also a low-flow fluid delivery device (such as a scrub sponge), fluidly coupled to the outlet of the continuous flow pump for receiving the fluid being pumped by the continuous flow pump and delivering the fluid to a user.

### TECHNICAL FIELD

This application relates to fluid management systems and in particular to a compact, battery powered, lightweight, portable system for pumping a fluid such as water from an external water source and enabling a user to shower, wash or clean other materials with a low flow device such as a sponge, using minimal power and water consumption.

### BACKGROUND OF THE INVENTION

Many situations exist in which it is desired to reduce substantially the amount of water required for cleaning a person, animal or object. For example, persons camping in a remote location are often unable to clean themselves and/or their pet, wash dishes, etc. due to the lack of available clean water and need to conserve what little amount may be available.

Reference is made to this inventor's U.S. Pat. No. 11,933,317 LOW-FLOW FLUID DELIVERY SYSTEM AND LOW-FLOW DEVICE THEREFOR, which discloses the direct dispersion of fluid through a low-flow device and from a pump that rapidly turns on and off (near-zero pressure cycles). When used herein, the term “low flow device” or “low flow fluid delivery device” is a cleaning or treatment implement that mechanically alters the condition of a surface while dispersing a fluid continuously via a tube inside the implement. This helps a user shower or clean an item while making the most of every drop of any fluid such as water. In the '317 patent, an RV diaphragm pump (which includes a pressure-activated on/off switch on the outlet side) disperses fluid through a user-controlled valve, hose, and out of a sponge at the head of the hose (instead of a shower head). The user adjusts the valve and cleans with the sponge (that disperses fluid) by directly applying each drop of fluid exactly where it's needed. The user controls the rate at which the pump rapidly turns on and off by adjusting the aperture of the valve. See the '317 patent for more information about the pump that manages fluid and the variety of low-flow devices that mechanically clean while directly dispersing fluid.

This technology established a major break-through in the realm of showering and cleaning gear with minimal amounts of fluid. The first introduction of this technology was through a product called the GEYSER SYSTEM. Users obtain the same satisfactory, refreshing sense of a shower while dispersing fluid through the sponge (instead of a showerhead). It is the first product using an RV diaphragm pump, valve, and sponge. This system can make its 0.8 gallon container last up to a 15 minutes wash time. It provides a range of flow rates between 0-1 gallons per minute. To provide reference, most residential and camping showers in the market operate with flow rates between 1-2.5 gallons per minute (gpm). The standard shower requires between 5 to 25 gallons of fluid. The GEYSER System was proven to make a leap in fluid conservation in situations where fluid resources (as well as heating, grey fluid management, filtration, etc.) were limited.

Additionally, less fluid consumption comes with other important benefits, i.e., significantly less space, weight, and heat time necessary than most showers. In fact, the GEYSER System is completely portable for vehicles, weighs 13 lbs when full, only requires 1 liter of fluid, and is more compact than any other camping showers in the market.

As mentioned, the GEYSER System uses an RV diaphragm pump with a pressure activated on/off switch found within the head of the pump. As a matter of practicality, it is one of the smallest and most cost-efficient means to manifest this result today is via a diaphragm pump producing up to 1 gallon per minute, consuming between 24 to 36 watts, weighing 1 lb, and relatively low costs. This is small and energy efficient enough for connecting to a vehicle's battery (i.e., marine or car battery). However, this pump presents several physical and battery limitations for people seeking to shower while being far from a 12 VDC power source (such as when backpacking).

Reference is also made to a product referred to as the GEYSER ECOSHOWER. This product is intended for customers seeking to conserve fluid in any situation (camping or residential). Unlike the GEYSER System's complete assembly for fluid management (fluid container, heating element, pump, valve, and sponge), the GEYSER ECOSHOWER is simply a flow valve connected to a one foot hoseline with a sponge at the end of the the hoseline. The GEYSER ECOSHOWER was designed to replace the handheld shower wand in one's shower. The GEYSER ECOSHOWER is unique in how it holds and interchanges a sponge. At the end of the hoseline it includes a flexing cam or bow that expands within a sponge with diamond pattern stitching that receives the cam or bow. Unlike the first generation sponge that was launched with the GEYSER System, the GEYSER ECOSHOWER allows the user to interchange the sponge easily and allows the company to provide a low-cost sponge with CNC stitching. This is disclosed in U.S. Pat. No. 12,232,674 ANCHORING AND RELEASE SYSTEM TO SECURE A LIQUID RELEASING TUBE INTO A LOW-FLOW DEVICE. This assembly can be connected to any shower in the market (regardless of fluid source, delivery, or management). This includes showers connected to a fluid grid (such as one's home) or off the fluid grid (such as an RV or boat).

Originally, the GEYSER ECOSHOWER was designed to conserve fluid at home. However, users who already have a shower stall within an RV or boat quickly adopted it so that they can boondock (i.e., remain off the grid and not rely on an RV hookup) for longer periods of time. These users already have a RV diaphragm pump connected to a showerhead (normally a handheld shower wand hanging off the wall of the shower stall) that operates the same as the RV diaphragm pump within the GEYSER System. Despite the fact that this sponge is unique, it also is related to the '317 patent, because, when combined with an RV diaphragm pump and shower stall valve sending fluid through a sponge, this results in the same result; near-zero pressure cycles using low flow devices.

Both the GEYSER System and GEYSER ECOSHOWER have obtained great success in a handful of situations and circumstances where fluid such as water is limited. This is especially true for vehicle-based camping (such as overlanding, van life, and RVs) where fluid could still be carried within the vehicle. Regardless of the pump being within the GEYSER System or the pump being a part of the RV's plumbing, all pumps required a 12 VDC battery. While the physical requirements of battery and fluid for operation were transportable via vehicle, we knew that neither the GEYSER System nor other RV diaphragm pumps were practical for backpacking or primitive camping. The size and weight were too large for people in remote situations where a 12 VDC battery was not available. This includes but are not limited to situations such as backpacking, primitive camping, hunting, and ultra-light expeditions such as rafting. These people seek the same fluid-saving and hygiene benefits of the GEYSER System, but in a more compact, lightweight, energy-efficient form.

While the GEYSER System proves people's desire to reduce fluid consumption through a low-flow device (which makes fluid more convenient when off-the-grid or remotely camping near a vehicle), the pump's size, weight, power consumption, and battery size requirements introduce limitations for the user attempting to achieve a higher degree of portability (such as backpacking) or energy efficiency (such as a 5V battery bank).

More specifically, today's RV diaphragm pump used within the GEYSER System requires a degree of dependency on heavy batteries, a car's power supply, or large solar panel. Additionally, the GEYSER System requires one connects it to a 12 VDC power supply (such as a vehicle's cigarette socket). This power supply requires at least a motorcycle battery, which becomes prohibitively heavy and bulky in cases where portability is critical.

Additionally, today's GEYSER System is too large (11″×17″×9″) and heavy to carry in a backpack (11 lbs when full of fluid). The size and weight make it impossible to primitively camp in a remote site where the user has hiked for 3-15 miles with a backpack of gear and are located far away from vehicles. The lack of portability also adds costs when trying to ship to fluid-stressed regions of the world, such as South Africa, where this technology could be useful but is unaffordable.

Today's GEYSER System also cannot allow a user to remain clean for long periods of time (or multiple uses) without using limited electricity in a vehicle and introducing new problems. More specifically, the user may prefer that his/her RV or campervan stays in remote for long periods of time without turning the engine on and remain disconnected from a source of power on the grid (boondocking). During this time, the user may also decide to use their GEYSER System multiple times while connected to their recreational vehicles or campervans 12 VDC socket, which is supplied by the vehicle's starter battery or auxiliary battery system. In the instance where the engine is not turned on long enough to give the alternator adequate time to recharge batteries, using the pump for extended periods of time could drain the vehicle's starter battery and leave the user in a remote area without capacity to start the vehicle's engine. This is case, a means to make the most of every drop of fluid while using less power would leave the user with adequate power to do other important things such as, but not limited to, restarting the vehicle's engine.

Given the constraints of the prior art, a way to maintain hygiene or clean gear while making the most of every drop of fluid and minimizing energy consumption is needed. It is desired to achieve a minimal level of hygiene with a sponge and a small water supply (e.g. a NALGENE bottle (1 liter) of fluid (one of the most common fluid bottles used by primitive and backpacking campers) while using the least amount of power (5V cell phone charger). This goal would require maximizing the energy efficiency of the pump beyond today's available options within the RV diaphragm pump market. In the present invention described herein, the inventor implements a micro-diaphragm (or mini-diaphragm) pump.

There are important differences in the mechanical effect of the micro or mini diaphragm vs RV diaphragm pump, as follows.

Mini/Micro-Diaphragm Pump—Uses an off-center cam that converts the motor's rotational movement into the reciprocating oscillation of a plunger-style diaphragm. The diaphragm creates suction (when the plunger is pulled down) to draw fluid from the inlet through one-way inlet valves and then creates pressure (when the plunger is pushed up) to discharge fluid through one-way outlet valves towards the outlet of the pump. Some unique features are that the inlet and outlet check valves are passive and do not require additional springs, and the cam is direct and motor power is transferred directly.

RV Diaphragm Pump—Uses an eccentric camshaft that converts the motor's rotation movement into the asymmetrical rotor. This rotor stretches the diaphragm back and forth in a non-linear fashion. In most cases, the rotor is attached to the diaphragm via connecting rods to deliver the push and pull action. The check valves are active and require additional springs to prevent backflow. Motor power is transferred through multiple components that are not centered and therefore allow a much more optimized pumping action and superior volumetric efficiency.

### Fluid Filtration & Purification

In terms of fluid filtration and purification, it is understood that filters require the least amount of effort when the filter is clean and new. However, these filters collect particulate over time. Almost all filters require the user to regularly backflush the filter to maintain filter performance and avoid getting clogged. The primary shortcoming in today's products is the need to backflush the filter when clogged with particulate. The backflushing (sending clean fluid in the opposite direction) requires lots of energy, time, and pressure. In some cases, the user fails to overcome the clogged filter, applies too much backpressure, ends up breaking the instrument (fluid bag or bottle) in which the user is applying the backpressure, fails to backflush the filter, and is left with an inoperable product. This is typically the case for users who filtered fluid that it is too dirty or left the filter for a long period of time without backflushing the filter immediately after filtering fluid. In most cases, by the time the filter needs to be backflushed, it's already too late and the filter is not recoverable.

It is therefore desired to provide a way to effortlessly and regularly maintain the cleanliness of the filter is needed before it becomes too clogged with excess particulate.

Additionally, filters generally do not have a way to notify the user of the health of the filter (i.e., the degree of which it's clogged with particulate). The user can only subjectively assess the health of the filter by the amount of forward pressure required to pass through a certain amount of fluid over a period of time. These factors are not easy to measure nor combine without further instrumentation. It is therefore desired to provide a way to determine the quality and performance of the filter.

Additionally, this is further complicated by the kind and varying amounts of contaminates in dirty fluid. For example, some streams present fluid with less particulate while static fluid in lakes could present more particulate. Another example, some muddy fluid contains fine dirt, while green fluid contains algae.

It is therefore desired to provide a way to properly maintain the optimal performance of the filter regardless of the size, quantity, type, or other characteristics of the particulate in dirty fluid.

Additionally, this is further complicated by user's desired fluid quality after filtration. Some users desire the fluid be filtered (removal of bacteria) but will accept a lack of purification (elimination of viruses). In some cases, the user may want fluid that adequately cleans for a shower or cleaning gear. In this instance, the extra effort of purifying fluid for drinking may not be necessary. This effort of creating adequate levels of drinking fluid is considerable when one regards a shower requiring 1-3 gallons of fluid in primitive camping situations.

Other users seek the fluid be purified and eliminate viruses (i.e., adequately cleaned for drinking fluid, but too clean for a shower). Obviously, the latter of the two outcomes requires finer filtration which is more susceptible to becoming clogged if the user doesn't introduce fluid that has already been passed through some filtration of larger particulate. For that reason, sophisticated products in the market come with multiple filters and self-cleaning features, which are prohibitively expensive.

It is therefore desired to provide a cheaper, more efficient, faster, and/or easier solution that specifically meets one's needs and degree of which the fluid is cleaned.

Most filters are very labor intensive, in that they require hand pumping, sucking, pressing, squeezing, hanging, swishing, etc. The only filter that doesn't require such intense labor are UV filters. UV filters, however, do not remove large particulate. All solutions, including UV filters, require steady attention and management by the user. A less manual solution that requires almost no attention by the user is needed. In other words, the user sets up the fluid infrastructure, presses a button to initiate filtration or purification, and steps away while the fluid infrastructure independently completes the task. The user, in the meantime, can attend to other activities such as pitching up one's tent or cooking while the fluid infrastructure is filtering or purifying fluid.

### Heating Fluid

Various devices are implemented in remote locations, such as camping, in order to heat a supply of water, whether for cooking, cleaning or showering. In particular, users often desire to heat the fluid (e.g. water for cooking or showering) as quickly as possible.

In one example, the JETBOIL FLASH and MSR WINDBURNER have been recognized as two of the fastest and easiest products that boil a liter of fluid in ninety seconds. This is achieved in a 1-liter pot uniquely designed with fixtures beneath to capture and transfer heat coming from the burner and into the pot. However, some users complain how complicated it is to manage once boiling. While it's not a critical failure in design, many users have to overcome the danger of managing the burner's gas regulator directly below the pot as boiling fluid is bubbling over the edge of the said pot and burning one's hand with boiling fluid. A lid prevents this. However, the lid doesn't present the status of fluid boiling. Users are willing to deal with these shortcomings and obstacles because the quick heating of fluid is so important to them. It is therefore desired to provide an easier, fast, and more efficient way to heat, boil, manage, and disperse fluid such as water.

A hallmark quality of the JETBOIL are the unique features that makes more efficient transfer of heat from the burner to the pot. More specifically, the fins underneath and welded to the pot capture the heat and transfer it into the pot. This is more efficient than delivering a previous camping stove that directly deliver a flame underneath the pot. However, little is done to maximize the transfer of heat from the inside of the pot and into the fluid. In fact, the user must rely on some amount of convection so that cooler fluid at the top of the pot gets sent to the bottom. This natural organization of fluid as well as lack of fixtures within the pot leaves plenty of room for efficient heat transfer within the pot. Of course, the manipulation of fluid within the pot requires additional fixtures, sensors, and pumps.

It is therefore desired to provide a way to quickly and more efficiently heat fluid such as water.

Camping stoves are traditionally the way people boil water. Camping stoves are not closed, pressurized systems since they have an open end of the pot or kettle to allow the free release of hot air. However, since all camping stoves are limited to the amount of fluid in the pot or kettle, they do not heat an endless supply of boiling fluid. To achieve more boiling fluid, the user must refill the pot/kettle, wait for a period of time until the fluid is boiling, and pour that amount of fluid out.

For these reasons, instant propane fluid heaters or tankless fluid heaters are in demand. These products provide refined control as well as endless hot fluid as long as it's connected to a large source of fluid (such as a large container or stream). In other words, the fluid supplied through the heater goes through a heat exchanger over propane flames and the fluid is delivered at the temperature desired by the end user (normally selected through a temperature dial on the fluid heater that adjusts the size of flame underneath the heat exchanger). They deliver much more heat than a camping stove (e.g., 41K to 100K BTU/hr), can use a variety of gases (propane/natural gas), and are commonly found in residential applications.

However, these heaters come with many limitations, including their bulk and size, and the requirement of lots of propane to heat so much fluid (flowing between 1.5-5 gpm). As such, they cannot be used for backpacking and are limited to vehicles.

It is therefore desired to provide a smaller, more compact version of the tankless fluid heater that delivers the same or better heating performance in backpacking or camping situations.

Additionally, instant propane fluid heaters include a heat exchanger (or array of exchangers). Unlike the pot or kettle, this system is closed and cannot easily contain, manage, or deliver boiling fluid. Boiling fluid within the heater builds pressure within the system and can induce a failure to the components or serious danger and/or death to the user. Some instant hot fluid heaters include thermostats and logic to prevent this from happening. This drives additional complexity in the system and cost.

It is therefore desired to provide an instant hot fluid heater that can safely and easily deliver boiling fluid without building dangerous pressures inside.

Perhaps the greatest shortcoming of instant hot fluid heaters is the requirement of fluid flow to start heating fluid. All instant propane fluid heaters include a flow sensor and logic to start or stop heating. When a user starts a pump, the flow sensor within the instant hot fluid heater recognizes the demand for hot fluid and starts the ignition of propane/natural gas. When a user stops the pump, the fluid heater stops dispersing the propane and stops heating fluid standing within the system. Most instant hot fluid heaters require at least 0.5 gpm to start heating fluid. In the most conservative of examples, the CAMPLUX fluid heater requires 0.3 gpm to flow within the system before starting the ignition, lighting the propane gas, and sending heat into the heat exchanger. This design introduces two situations that waste fluid. First, to have a hot shower requires at least 0.3 to 0.5 gpm, which represent 2 to 5 times more fluid needed than the minimal criteria of “refreshing shower” identified with the GEYSER System. Second, users complain that the 1-2 minutes of using instant propane heaters require one waste 1-4 gallons of fluid while waiting for it to become hot. In some cases, users introduce way too much heat at the beginning of their shower and, once the heater begins delivering hot fluid, complain that it's too hot and continue to waste fluid after turning the temperature dial down. Attempting to set and leave the temperature dial is not effective. The users also must adjust the temperature dials between showers because the outcome is highly dependent on the initial temperature of the fluid going into the heater. There is a need to quickly, accurately manage the fluid within a heater to achieve a specific result without excessive flow rates nor wasting fluid.

### SUMMARY OF THE INVENTION

In accordance with these and other objectives, provided is a portable, compact, battery-powered fluid management system that includes a plurality of fluid management modules arranged in accordance with the desired objectives of the user. The fluid management modules include at least a continuous flow pump having an inlet for drawing in a fluid, such as water from a water bottle or other fluid supply and pumping the fluid out through an outlet in a continuous, non-pulsatile manner. There is also a low-flow fluid delivery device (such as a scrub sponge), fluidly coupled to the outlet of the continuous flow pump for receiving the fluid being pumped by the continuous flow pump and delivering the fluid to a user.

A bottle stopper is fluidly coupled to the pump inlet or surrounding the inlet tube at a distance from the pump inlet, for mating with a fluid bottle that contains the fluid being pumped. The bottle stopper has a tube passageway into which an inlet tube is inserted for drawing fluid from the fluid bottle to the continuous flow pump. Optionally, a one-way air valve (or simply an aperture) is provided to prevent a vacuum in the fluid bottle while the fluid is drawn from the fluid bottle to the continuous flow pump. The bottle stopper may for example be press fits within a neck of the fluid bottle (like a cork), or it may preferably have threads to mate with the threads on a neck of the fluid bottle (like a lid).

The low-flow fluid delivery device may for example be a scrub sponge, a wet comb, a loofah, or the like. The low-flow fluid delivery device can be made of any material: natural cellulose, plastic, or the like.

A valve may be fluidly coupled between the outlet of the continuous flow pump and the low-flow fluid delivery device, which may be mechanically operable by a user of the system to control the flow rate of the fluid being pumped as desired.

Optionally, a controller is provided for enabling a user to control electronically the operation of the system, such as a potentiometer that adjusts a voltage supplied to the continuous flow pump in order to vary a flow rate of the continuous flow pump. The controller may have a user interface operable by the user, for controlling a flow rate of fluid flowing from the continuous flow pump to the low-flow fluid delivery device.

The controller may also provide fluid flow rate feedback to the user for the fluid flowing to the low-flow fluid delivery device. In this case, the system may also include at least one sensor for measuring the fluid flow rate.

### BRIEF DESCRIPTION OF THE DRAWING

FIG. 1 is a perspective view of a preferred embodiment portable fluid management system of the present invention.

FIG. 2 is a block diagram of the preferred embodiment of FIG. 1.

FIG. 3 is a block diagram of an alternative embodiment of the invention.

FIG. 3A is a top view of a first embodiment of a bottle stopper.

FIG. 3B is a bottom view of the bottle stopper of FIG. 3A.

FIG. 3C is a top view of a second embodiment of a bottle stopper.

FIG. 3D is a bottom view of the bottle stopper of FIG. 3C.

FIG. 4 is a perspective view of an alternative embodiment portable fluid management system.

FIG. 5 is a flow diagram of a first alternative embodiment portable fluid management system.

FIG. 6 is a flow diagram of a second alternative embodiment portable fluid management system.

FIG. 7 is a flow diagram of a third alternative embodiment portable fluid management system.

FIG. 8 is a flow diagram of a fourth alternative embodiment portable fluid management system.

FIG. 9 is a flow diagram of a fifth alternative embodiment portable fluid management system.

FIGS. 10-16 are various diagrams of a heating system applicable to the present invention.

FIG. 17 is an alternative diagram of a heating system applicable to the present invention.

### DETAILED DESCRIPTION OF THE INVENTION

### Clarification & Terms

The following references to the GEYSER System may include the term “shower”. In the normal context, a shower includes fluid sprayed through a shower head. Unfortunately, the term “shower” continues to be the best word to describe washing one's body with a low-flow device (for example, but not limited to, a sponge that directly disperses fluid as you clean with the sponge). In this patent application, the word “shower” only refers to cleaning one's body or gear with a low-flow device (such as a sponge at the end of the hose line), not a shower head (unless specifically stated).

When used herein, the term “low flow device” or “low flow fluid delivery device” is a cleaning or treatment implement that mechanically alters the condition of a surface while dispersing a fluid continuously via a tube inside the implement.

The terms “mini-diaphragm pump” and “micro-diaphragm pump” are used interchangeably throughout this specification as described herein.

The following may refer to fluid as the primary or likely fluid managed by the system. Fluid can also be replaced with other fluids such as cleaning solutions with agents such as bleach or liquids that achieve certain results beyond cleaning. This includes but is not limited to the eliminate or minimize the negative impact of harmful agents (such as anthrax) on one's body after a bioterrorist act. It can also include liquid for removing carcinogenic soot left on a firefighters body. It can be fluid with varying degrees of filtration and/or purification. It can include a medicinal or chemical agent for rapid wound management.

The following may refer to sponge or scrub as the primary means of dispersing fluid by the system. Sponges can also be replaced with other low-flow devices such as but not limited to dog brushes, gauze, band aids, dressing, wet combs, and loofahs. In all cases, low-flow devices do not produce a spray similar to shower heads nor create mists of fluid as a means of dispersion. Low-flow devices include the use of a mechanical cleaning implement at the end of a hoseline so that the user can directly apply the fluid where needed. In some cases, the mechanical cleaning implement may be detached from the tube and left behind on the area of concern (such as a band aid or wound dressing).

The following may refer to a filter as a primary means of modifying a quality of fluid. This can be interchanged with other modifiers of fluid including, but not limited to, dispensers, purifiers, etc. The word filter can be used interchangeably with other modifiers of liquid.

Items to be cleaned (or directly dispersed with any fluid) include but are not limited to any physical item. Examples include a human body, hair, dog, dishes, outdoor gear, car exteriors, boat, wounds, horses, children, car interiors, etc.

This technology in this patent can be used but not limited to a variety of locations, vehicles, or situations, such as flying vehicles within and outside of Earth's atmosphere, DECON Hazmat situations such as a bioterrorist act, marine vessels, submarine vessels, forward operating bases, wound management, operating tables, any situations that exists on this planet or other planets beyond Earth, etc. While the intention of the design is for situations where fluid is limited, it may also be used in situations where fluid management is inconvenient. For example, cleaning elderly people in hospice while laying in bed.

This technology can be portable (in a backpack) or permanently secured (e.g. to a vehicle or home).

Parts of this idea may refer to “fluid infrastructure” to describe a system of components that manages fluid. This is also equivalent to the term “fluid management system” or “FMS”.

The preferred embodiment of the present invention provides the most energy-efficient fluid infrastructure (or fluid management system) possible. Additionally, this infrastructure could be customized around the customer's objectives and situation. That is, the customer could purchase an array of common components (pumps, filters, controllers with firmware, heaters, pots/kettles, valves, sensors, batteries, etc.) and easily put them together in a configuration to achieve their desired results (boil fluid, clean fluid, purify fluid, etc.) with the least amount of energy consumed.

The fluid infrastructure (see Fluid Management System for more details below) achieves one, some, or all the following:
A more energy-efficient, space-saving, weight-saving, and cost-effective way to pump fluid through a low-flow device, filter, heater, purifier, manual/automatic valves, and/or sensors
Filters and/or purifies fluid automatically with little to no effort nor attention by the user.
Monitors, identifies, adjusts, and alters the condition within a filter, purifier, and/or heater.
Modifies fluid by dispensing other material to enhance the fluid.
Backflushes filters automatically with little to no effort by the user
Heats fluid continuously (limited by the amount of fluid or gas available)
Heats fluid more quickly, efficiently with the use of heat exchangers and flow control within a pot or kettle
Operates off minimal heat (therefore fuel) requirements.
Makes hot or boiling fluid easier to manage or dispense.
Quickly and accurately manages fluid within a heater to achieve a specific result without excessive flow rates nor wasting fluid.
Safely and easily deliver boiling fluid without building dangerous pressures inside
Is smaller and more compact than instant (tankless) hot fluid heaters.
Operates off minimal voltage and amperage (therefore power) requirements

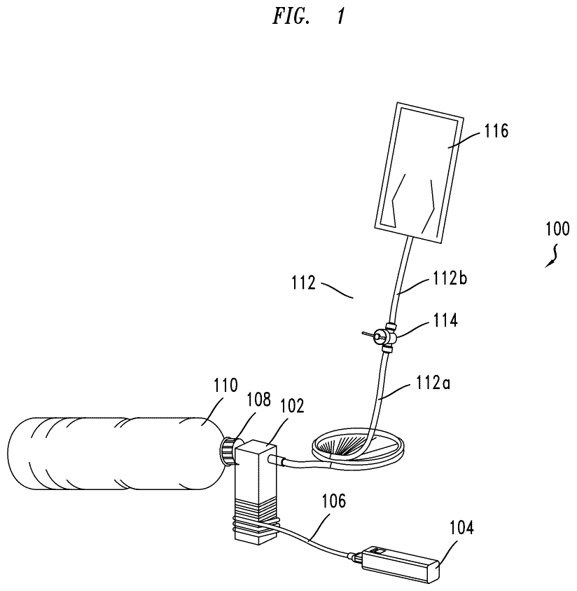

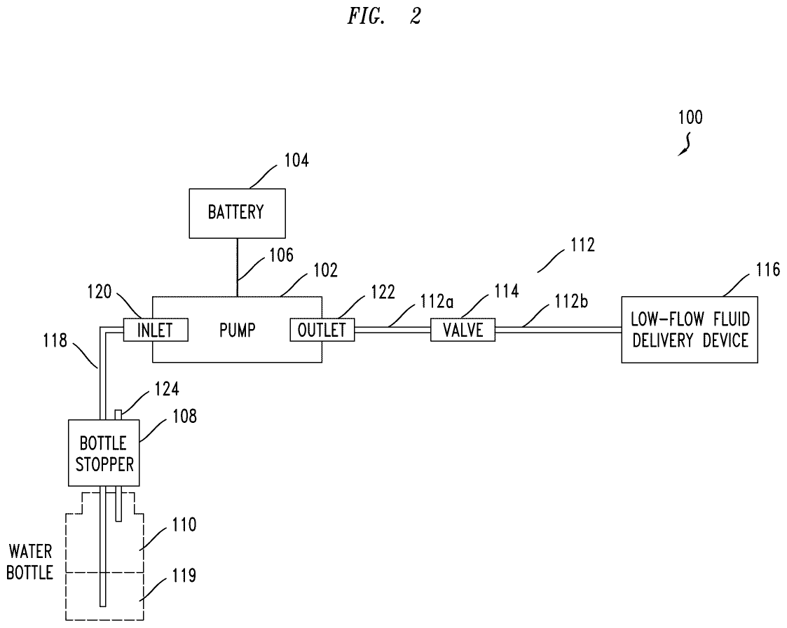

FIG. 1 is a perspective view of a preferred embodiment portable fluid management system 2 of the present invention, and FIG. 2 is a block diagram of the preferred embodiment of FIG. 1. The fluid management system 100 includes a continuous flow mini-diaphragm (also known in the art as micro-diaphragm) pump 102, which draws fluid in from an external fluid source such as a water bottle 110 and pumps the fluid out of an outlet 122 through an outlet hose 112. The outlet hose 112 is preferably split into two sections; a lower outlet hose 112a and an upper outlet hose 112b, as shown. A manually operated valve 114 is inserted between the lower outlet hose 112a and the upper outlet hose 112b to enable control of the water flow through the pump 102. A low-flow fluid delivery device 116, which in this preferred embodiment is a scrub sponge, is coupled to the upper outlet hose 112b via an anchor (not shown) at the end of the upper outlet hose 112b and inserted into the low-flow fluid delivery device 116. Details on this configuration are found in U.S. Pat. No. 12,232,674, ANCHORING AND RELEASE SYSTEM TO SECURE A LIQUID RELEASING TUBE INTO A LOW-FLOW DEVICE, the disclosure of which is incorporated by reference herein.

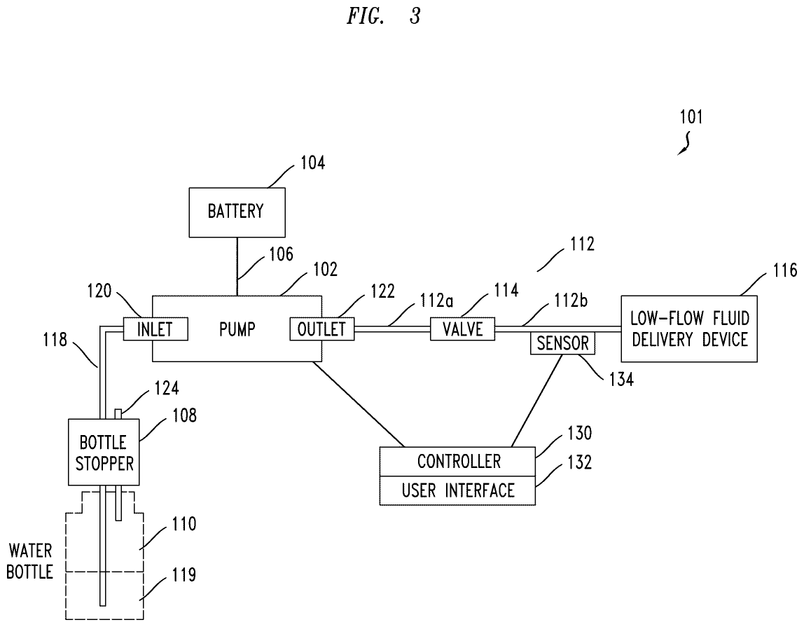

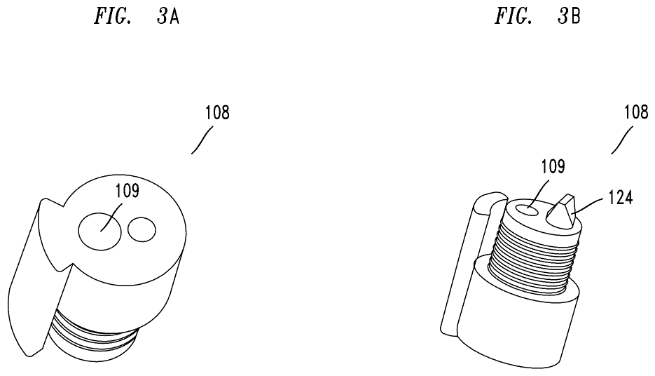

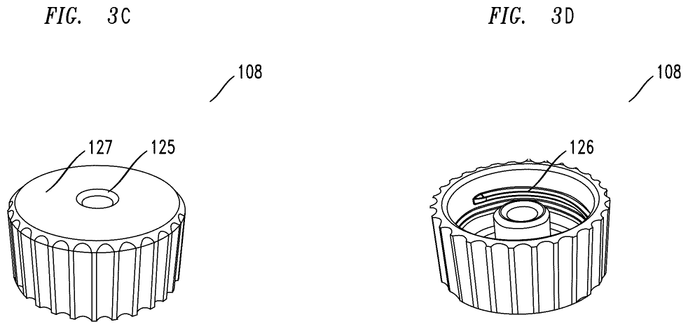

The pump 102 is provided with operating power via a USB power cable 106 that provides 5 VDC power from a battery pack 104 as known in the art. A bottle stopper is shown for coupling the inlet 120 of the pump 102 to the top of the water bottle 110. FIG. 3A is a top view of a first embodiment of a bottle stopper; FIG. 3B is a bottom view of the bottle stopper of FIG. 3A. FIG. 3C is a top view of a second embodiment of a bottle stopper; FIG. 3D is a bottom view of the bottle stopper of FIG. 3C.

The bottle stopper 108 is shown for coupling the inlet 120 of the pump 102 to the top of the water bottle 110. The bottle stopper 108 has an inlet tube 118 running through a tube passageway 109 (see FIGS. 3A, 3B) to enable the pump 102 to draw water in from the supply of water 119 found in the bottle 110. The bottle stopper 108 shown in FIGS. 3A, 3B may press fit within the neck 111 of the water bottle 110, or the bottle stopper of FIGS. 3C, 3D may be threaded 126 to fit any standard water bottle 110 that may be found in the prior art, thus enabling the use of an off-the-shelf water bottle (e.g. a water bottle from POLAND SPRING) as a source of water for the user to take a shower using the present invention. An additional adapter may be provided that enables the bottle stopper 108 to be used with other water containers, including but not limited to NALGENE bottles, DOMETIC water supplies, Jerry cans, Rotopax units, etc. The bottle stopper 108 in FIGS. 3a, 3b illustrate the optional one way air valve 124 to prevent a vacuum in the water bottle 110 while the fluid 119 is drawn from the water bottle to the continuous flow pump 102. The bottle stopper 108 in FIGS. 3c, 3d illustrate the optional one way aperture 127 to prevent a vacuum in the water bottle 110 while the fluid 119 is drawn from the water bottle to the continuous flow pump 102.

In the preferred embodiment, the entire system 100 is sized to fit within the space of a NALGENE bottle. As such, the user could keep the bottle stopper 108, pump 102, outlet hose 112 (and/or lower and upper outlet hoses 112a, 112b, and control valve 114), and low-flow delivery device 116 inside an empty NALGENE bottle, which would then easily fit inside the user's backpack or rucksack.

FIG. 3 is a block diagram of system 101 in accordance with an alternative embodiment of the invention. This embodiment is similar to that of FIGS. 1 and 2, and includes additional components such as a controller 130, user interface 132, and sensor 134. The sensor 134 measures a flow rate of the fluid provided to the low-flow fluid delivery device and generates a flow rate signal corresponding to the measured flow rate. The controller 130 is coupled to the sensor, receives the flow rate signal from the sensor, and enables the user to control electronically the operation of the system. A user interface 132 is coupled to the controller, for providing feedback to the user regarding the measured flow rate, and controlling a flow rate of fluid flowing from the continuous flow pump to the low-flow fluid delivery device. The controller 130 enables the user to control electronically the operation of the system, for example with a potentiometer that adjusts a voltage supplied to the continuous flow pump 102 in order to vary a flow rate of the continuous flow pump.

The low cost of the pump 102 also opens the possibilities of creating a modular and additive array of other multiple pumps 102 and components needed to manage fluid delivery, filtration, and/or heating. This array is intended to be the most energy-efficient and mobile fluid infrastructure possible, while allowing the user to customize and select the components needed to achieve their goals. This is done by the user adding and connecting additional pumps 102, control valves 114, optional controllers 130 with firmware, low-flow devices 116, and/or sensors 134 together, all of which are selected and interconnected by the user to meet the user's objectives.

Achieving these results are accomplished through one or more continuous flow mini-diaphragm (also known in the industry as micro-diaphragm) pumps 102. At a high level, these pumps 102 are used to send fluid through one or more low-flow devices 116, manual control valves 114, automatic valves, sensors, filters, purifiers, heater, dispensers, tubing, fixtures, controllers with firmware, or pots/kettles using any heat source.

RV Eccentric Pump Vs. Micro/Mini-Diaphragm Pump

Another difference between the RV eccentric pump and micro diaphragm pump is the suction strength at the inlet of the pump. With regards to self-priming, it's known that RV eccentric diaphragm pumps can lift fluid through a vertically standing tube higher (generally capable of pulling fluid through tubing standing beyond 10+ft high) than micro diaphragm pumps (generally capable of pulling fluid through tubing standing a total height of 3-6 ft). It's also known that RV eccentric pumps are better than micro-diaphragm pumps at sucking out air bubbles from the inlet and managing air pockets within the pump's chamber. These advantages of the RV eccentric pump come with significantly higher energy consumption, mechanical complexity, and cost of manufacturing.

The RV pump's superior suction and self-priming performance is due to its ability to reduce pressure and create vacuums inside the pump's chambers. Moments of reduced pressure are dependent on diaphragm movement (directly driven by the eccentric rotor) along with the pump's ability to continuously create staged conditions of vacuum through different chambers pulling fluid at different times. For these reasons, RV pumps provide more stable suction force, better air-handling capability, greater ability to overcome dry-start conditions, and are more effective overcoming increasing vacuum conditions when compared to micro diaphragm pumps.

The micro diaphragm pump's weaker suction and self-priming performance is due to the softer, plunger-style diaphragm's limited capacity to create reduced pressure within the pump chambers. The plunger is not directly-driven by a stiffer mechanism such as a rotor or connecting rod. The softer diaphragm pulls and pushes with less pressure, but comes with the advantage of requiring lower energy consumption from the motor, mechanical complexity, and cost of manufacturing.

Therefore, it's known that micro diaphragm pumps have less suction strength, generate weaker vacuums, and struggle to prime or pull fluid or air in the presence of resistance created by a vacuum condition.

In this design, the user may opt to use a bottle as their source of fluid. Attaching the bottle's opening to the pump's inlet (or inlet tube) can result in accidentally tipping the bottle and spilling the limited fluid during the cleaning process. More specifically, the bottle's taller stature will continuously present a risk of tipping over while the user accidentally tugs the outlet hoseline, adjusting the pump's position, and transferring the tension to the inlet of the bottle. Additionally, the additional weight of the pump at the top of the bottle makes the bottle top heavy and greater risk of tipping. Therefore, it's advantageous to prevent this predicament by letting the bottle rest on its side before starting the washing process. Achieving this requires a stopper or lid with a hole that simultaneously allows fluid to be drawn by the inlet of the pump or inlet tube while also sealing the outer surface of the pump inlet or tube to prevent leaking fluid.

The addition of a stopper or lid to cover the opening of the bottle does seal it while allowing the bottle to rest on its side. However, sealing the bottle's opening and pump's inlet (or tube's inlet) with this stopper or lid presents three new challenges.

First, overcoming vacuum resistance inside the bottle as fluid is being removed. More specifically, as the fluid is drawn from the bottle, the volume is replaced with a vacuum within the sealed bottle. If the bottle is made of pliable material (for example, 1.5 L standard water bottle), then the bottle will collapse, which causes the bottle structure to degrade over multiple uses and, in some cases, crack. If the bottle is made of stiff material (for example, 1 L Nalgene water bottle), the vacuum inside will eventually prevent fluid from being extracted, regardless of pump type. In the case of a 1 L Nalgene bottle, the total amount of water extracted is noticeably different when using an RV eccentric pump vs a micro-diaphragm pump. In other words, the RV diaphragm pump can extract more water for a longer period of time than the micro diaphragm pump. The micro diaphragm pump stalls sooner and is unable to extract all the water in the bottle due to its weaker suction strength.

Second, removing the stopper or unscrewing the lid after the vacuum is created. More specifically, the vacuum within a stiff bottle makes it tremendously hard (in some cases impossible) for someone to open the container, refill it with fluid, and prepare the next shower or wash. This is especially true for those with limited arm strength (such as seniors).

Third, the increasing vacuum condition within a bottle requires additional energy from the pump to deliver fluid. More specifically, drawing fluid while overcoming vacuum resistance requires more effort from the motor. This loss of efficiency wastes precious energy from limited power sources (such as batteries). In the instance where portability is important, the increased battery size and weight dedicated to overcome vacuum resistance becomes a disadvantage.

In lieu of overcoming these challenges with larger and stronger RV eccentric pumps, we include a means of air to enter the sealed container (such as via a tiny hole or one-way valve) on the stopper or lid. The ability to eliminate the presence of a vacuum allows the pump to freely draw water without resistance, allows the user to easily remove the lid (or stopper) when done using the container, and reduces the power consumed to overcome vacuum resistance.

The system is designed to be reverse compatible with any existing products in the market such as (but not limited to) filters, purifiers, heaters, sources of heat, or items modifying any characteristic of any fluid. The system is designed to accept any future products in the market such as (but not limited to) fluid filters, purifiers, heaters, sources of heat, or items that modify any characteristic of any fluid in the market.

The continuous flow mini-diaphragm pump 102 is the basic building block of the fluid infrastructure. The intentional use of a continuous flow mini-diaphragm pump comes with a variety of reasons.

Historically, these pumps 102 are not used for showering because of their low flow rates and low pressure. In other words, these pumps 102 are normally not selected to be used for sending fluid through a typical shower head (which requires additional pressure to shoot water from the shower head towards a person or object). Additionally, these pumps 102 are normally not selected to be used for heating or purifying fluid because, in most cases, the fluid demanded (for example: a hot shower at 1-2.5 gpm) is normally higher than what these pumps can provide. Reducing the overall fluid demand through low-flow devices (such as a sponge using. 1 to 0.2 gpm) allows the use of pumps 102 that deliver lower flow rates.

When fluid demand is reduced, there is a noticeable impact on other resources. For example, heating fluid for a shower at 0.2 gpm only requires an estimated 5,200 BTU per hour. This is well within the 9,000 BTU per hour specification of commercially available heating units (e.g. the JETBOIL FLASH). Therefore, this camping stove will be able to deliver a continuous hot shower as long as one pump introduces cold fluid and another pump draws hot fluid. Of course, fixtures would exist between the outlet of first and inlet of the second to maximize and separate the section of the JETBOIL pot with the hottest fluid. Additional firmware and sensors are required to control the flow rate of the pumps.

Very little fluid and pressure is needed for a user to feel refreshed and cleaned while showering with a low-flow device such as the scrub sponge 116. The preferred embodiment includes the use of mini-diaphragm pumps 102 along with one or a combination of the following:
a low-flow device to shower or clean
filters to clean fluid
purifiers to clean fluid
dispensers to modify fluid
pots/kettles to heat fluid
controllers that control pumps with firmware and/or provide power to the pumps with power cables. In some instances, the mini-diaphragm pump can run independently of a controller with its own firmware, internal battery bank, or external battery bank.

### Continuous Flow (Mini/Micro-Diaphragm) Pumps

Unlike the RV diaphragm pump (described above in the background section) which typically delivers between 1 to 5 gpm at 30-100 psi, continuous flow mini-diaphragm pumps operate at significantly lower flowrates and pressures. For this reason, these diaphragm pumps deserve a unique category or name of their own (continuous flow mini-diaphragm or micro-diaphragm). While there isn't a standard criterion for this category, these pumps are commonly identified by the following:
Voltage: DC 3V-24V
Fluid flow: 100-1500 ml/min (0.026 to 0.396 gallon per minute)
Pressure: 0.5-2 bar (7.25 to 29.00 psi)
Vacuum: −30-40 kpa (−4.35 to −5.8 psi)
Diaphragm Material: Silicone/EPDM/PTFE/FKM
Valve Material: Silicone/EPDM/PTFE/FKM

They are typically desired for applications where low noise, low vibration, and efficiency is desired. These pumps are self-priming. They can be found in many applications: beverage dispensers, liquid analysis and monitoring machines, inkjet printing, liquid dispensing, etc. Because of their low-pressure and low flow rates, they are not the pump of choice for showers that use shower heads.

These are typically supported by miniature DC brush motors and powered by 3-24 VDC. The preferred embodiment does not limit the type of motor supporting the pumping mechanism, and the preferred embodiment is also not limited to the power supply (DC or AC).

These pumps can include single-head (such as the KEYTO model 7121) or double-head (such as the KEYTO model 7122). This system is not limited to the number of heads on the pump.

The preferred embodiment includes but is not limited to the following common pump action of micro-diaphragm pumps. The following description is to only provide detailed clarity on how the mechanisms operate together. Other pump actions that deliver fluid within the realm of micro or mini diaphragm pumps are included in this embodiment. This system may use the following pump action to achieve greater flow rates, pressures, and vacuum pressures beyond the characteristics commonly identified in micro-diaphragm pumps. For example, this may deliver 1 gallon per minute (beyond 1500 ml/min or 0.396 gallons per minute) using the same pump action described below with the use of more chambers, valves, etc.

This embodiment includes a variety of materials used for the components of the pump. The materials include and are not limited to diaphragms nor valves made of silicone, EPDM, PTFE, or FKM plastics.

### Description of External of the Mini-Diaphragm Pumps

The basic building block of the fluid infrastructure includes a mini-diaphragm pump with the following.

Fluid inlet—This can be open or secured temporarily or permanently to the following items via any type of connector such as but not limited to CPC, press fitting, barbed, etc.
outlet of a hose
manifold
valve
coupler
T joint
sensor
filter
purifier
dispenser
heater
fixture within a heater (such as a heating element)

Fluid outlet—This can be open or secured temporarily or permanently to the following items via any type of connector such as but not limited to CPC, press fitting, barbed, etc.
inlet of a hose
manifold
valve
coupler
T joint
sensor
filter
purifier
dispenser
heater
fixture within a heater (such as a heating element)

Case—This surrounds (or makes up part of) the motor, valves, chambers, PCB (optional), battery (optional), plugs (optional), seals, or cover which allows easy access and swap of batteries.

In unique instances, the case may be integrated with the bottle stopper to include threads that easily allow the entire pump to be screwed onto a fluid container such as but not limited to a NALGENE bottle or military canteen, fluid filter such as but not limited to a Sawyer, or onto the top of a fluid heater such as but not limited to a JETBOIL Flash.

The case may also include additional features to easily secure the pump. This includes but is not limited to magnets to secure pump against a metal object such as the external side of a car, carabiner/hooks to secure the pump to a line, etc.

Cable, plug, inlet, or outlet—This allows the introduction of power and/or signals via a cable. In most cases, this feature will allow the pump to receive power and/or signals via a cable. There may be configurations where power or signals are sent via the cable. Therefore, this feature also exudes power and/or signals via a cable. This includes by is not limited to USB-C, USB-B, USB4, Micro USB, etc. The power can come directly from any 3 to 24 V source. The signal can come from the controller (see more details below).

The cable can be soldered directly to the internal PCB, switches, buttons, or motor within the pump case such that the cable becomes a permanent element attached to the external side of the pump. This could be an easier way to fluid proof the power source.

Alternatively, the external side of the pump can include an outlet that receives the male end of a cable. This could be disconnected between uses and be easier for wire management and storage.

Indicator lights, display, or sounds—This allows the user to know the status or condition of the pump or any other item connected to the pump: power source, filter, purifier, heater, fixtures, sensors, etc.

Button(s)—This allows the user to achieve one or a combination of the following
turn the pump on/off
modify the flow rate
connect to a controller
toggle through modes: filter, purify, heat
toggle through indicator lights, display, or sounds that present the status or condition of the pump or any other item connected to the pump: power source, filter, purifier, heater, fixtures, sensors, etc.

Any fixtures to easily connect to a bag, case, or manifold.

In most instances, these external features will be small and light enough for ease of use, portability, placement, and easy storage. For example, the pump will be able to fit and be stored within a NALGENE bottle. The externals of the pump are IP68 rated and designed to operate under fluid if the user chooses to leave the pump within a fluid source (container or body of fluid).

### Description of the Internals of the Mini-Diaphragm Pumps

These pumps typically include a variety of inlet valves, outlet valves, and diaphragm shapes and sizes to create the pump action of the liquid. An oscillating diaphragm creates a volumetric displacement within the pumping chamber, causing the liquid medium to be drawn in and expelled through specially designed valves.

In most cases, these diaphragms typically include one piece with multiple plungers. These plungers are connected to one side of the oscillating plate. The opposite side of the oscillating plate includes a pin at the center of the plate. This pin is connected to a cam/disc that accepts the pin in a hole near the outside of the cam/disc, therefore forcing the pin and the entire plate at an angle. The opposite side and center of the cam/disc is connected to the rotating pin on a motor. As the motor rotates the cam/disc, it causes the pin and plate to oscillate in a circular fashion. This causes the plungers on the diaphragm to suck fluid into and push fluid out of each chamber positioned near the plunger.

Each chamber includes (or shares) valves for the controlled flow of fluid in one direction. These valves are typically called inlet or outlet valves. These valves are typically of the umbrella type. Liquid easily flows in one direction (from underneath the valve, lifting the umbrella sides, and beyond the outsides of the umbrella). The liquid is blocked in the opposite direction by the natural form of the umbrella pressing against a wall.

This oscillation of the diaphragm in relation to the valves can be described by two phases: inlet phase and outlet phase.

The inlet phase—As the diaphragm retracts, it creates a vacuum, drawing the medium into the chamber through the inlet valve. During this action, the outlet valve prevents liquid at the outlet of the pump from entering the chamber.

The outlet phase—As the diaphragm moves forward, it pushes the medium out of the chamber through the outlet valve towards the outlet of the pump. During this action, the inlet valve prevents liquid from the chamber to arrive at the inlet side of the pump.

While this embodiment is not limited to the number of pump heads, the remainder of the description includes a pump with one pump head for ease of understanding the idea. This pump head will include four smaller inlet umbrella valves tied to 4 chambers. Each chamber has fluid drawn in and pushed out by a 1 diaphragm that consists of four plungers (one for each chamber). All four chambers include an outlet hole that is tied to 1 outlet umbrella valve (Larger than the four inlet valves and in between the four chambers).

This embodiment is not limited to the material, size, number, or shape of the inlet valves, outlet valves, diaphragms, chambers, or casing that surrounds or make part of the pump head.

Mini-diaphragm pumps are readily available in the market. See product listing below and attached datasheets from XIAMEN AJK Technology Co., Ltd. for models AJK-B2708 and AJK-B3204 for examples.

For additional reference, one can research liquid micro or mini diaphragm pumps found within manufacturers such as (but not limited to) BODENFLO, TOPSFLO, SKOOCOM, and KEYTO.

### Control of Flow Rates

Unlike the referenced prior art U.S. Pat. No. 11,933,31, this idea is achieved without a pressure sensor at the outlet of the pump. In fact, we are introducing the idea of managing fluid without a pressure sensor inducing “near-zero pressure cycles” or rapidly turning the pump on/off. In other words, this condition can be induced alone through firmware in a pump.

In most cases, the flow rate will be continuous, not pulsatile. Flow rates can be managed by the user in a variety of ways.

Mechanically—with the pump continuously on and the user reducing the flow rate mechanically with a manual control valve 114 distal of the pump outlet 122 (likely to be situated on a hose 112 distal to the pump outlet) and proximal of the low flow device 116. The manual control valve 114 can be of any type that includes a feature controlled by the user, including but is not limited to ball valve, butterfly valves, and/or roller clamps. Note that without a pressure sensor, the pump would remain on even if the user left the valve in the closed position. This design accepts that condition.

Electrically via the user—the user adjusts a knob (such as but not limited to a variable resistor or potentiometer in the controller 130) that manually adjusts voltage, or the user presses a button connected to a PCB with a pre-programmed IC (or firm-ware equivalent to variable resistors) that is stepping down or up the DC voltage supplied to the motor that runs the pump 102. Supplying different voltages to the motor of the pump 102 alters the speed of the motor and therefore causes the pump 102 to achieve different flow rates. On the user interface 132 of the controller 130, there can be one button to toggle through a limited number of flow rates (for example, one button toggles through 3 flow rates: low=0.1 gpm, medium=0.3 gpm, and high=0.5 gpm). Or, there can be two buttons: one to gradually increase the flow rates by smaller increments (for example: 0.05 gpm) and the second button to gradually decrease the flow rate by smaller increments.

Electrically from the controller 130 (or another pump assigned a master controller of all pumps)—as the name infers, a controller provides additional control of a pump. It's a separate device that manages one or more pumps along with other devices and sensors. A signal is sent from controller 130 to a pump 102 in response to a condition received through a sensor 134 connected to the controller 130 and/or the firmware internal to the controller. This can be done two ways: A controller (or firmware from another pump) sends a signal to the PCB within the first pump (which steps the voltage up or down) or sends a different voltage directly to the motor of the pump. A voltage or signal sent by the controller (or another pump) alters the flow rate of the pump. This voltage or signal is received through a cable (likely USB) connected between the plug of the pump and the controller (or another pump).

In most instances, it may be more cost effective for the manufacturer and end user to not absorb the cost of the PCB responsible for stepping the voltage up or down (which adjusts flow rates). Without the PCB adjusting the flow rates, the user will simply press a button to turn the pump on, activate the motor with a continuous DC voltage, and adjust the flow rate with a valve that is along the tube 112 (between the pump outlet 122 and low-flow device 116). This valve will restrict or open the flow of fluid while the motor and pump are operating at a continuous rate without change. When the valve is closed, the motor and pump will continue to operate at the same rate despite the restriction of the flow by the valve.

### How a User Builds a Custom Fluid Management System (FMS)

The mini-diaphragm pump 102 is the starting point for additional components that allow a user to create an infrastructure that manages fluid. A fluid management system (FMS) is defined as an array or configuration of pumps, filters, purifiers, dispensers, manual control valves, heaters, fixtures, controllers with firmware, low-flow devices, automatic valves, or sensors. These components arrive separately and are arranged and connected by a user into a configuration. The components can later be disconnected, stored, and reconnected into the same or different configuration. Again, the resulting configuration desired and created by the user will be called a Fluid Management System (or FMS).

At a high level (and to simplify the explanation), the user can create an FMS to achieve a certain category of goals, each category requiring its own configuration. We introduce the topic of configurations around three different categories of goals that the user may want to achieve through the FMS:
Washing Or Cleaning with Liquid—Mini-Diaphragm Pump & Low Flow Device for Washing & Cleaning With Liquid
Modifying, Filtering, and/or Purifying Fluid—Mini-Diaphragm Pump, Filters (or dispensers), & Controller for Removing Pathogens, Particulates, Bacteria, Protazoa, and Viruses from Liquid (or adding substances to liquid)
Heating Fluid—Mini-Diaphragm Pump, Heating Device, & Controller for Heating Liquid

These configurations are not limited to operating alone. In other words, a user can create an FMS with two or more of these three configurations. For example, an FMS can be configured with the components to draw dirty fluid, filter the dirty fluid of large particulate, then heat the filtered fluid, and then deliver this heated/filtered fluid through a low-flow device to clean one's body during a shower. As one can imagine, achieving this result requires multiple pumps and other components that merge the configurations together.

However, to simplify the explanation, the idea below explains each of the three different configurations as alternatives to the preferred embodiment of FIGS. 1 and 2 as if they were operating alone.

We begin the building of an FMS with an explanation of the fluid source. We then continue to explain the FMS with each of the three configurations: cleaning, filtering/modifying/purifying, and heating.

### Fluid Source

In all configurations, the inlet of the mini-diaphragm pump is connected to or left in a fluid source and, in some instances, the user could elect to add proximal of the pump's inlet a variety of components (hose, filters, etc.) that connect between the pump and the fluid source.

Additionally, other implements can be proximal of the pump to adjust or alter the quality of the fluid. This includes but is not limited to mixers to introduce cleaning agents into the fluid. This includes but is also not limited to filters or purification devices used to maintain the performance of the pump and/or achieve a certain quality of fluid desired by the end user.

All configurations require a source for fluid. The fluid can be supplied from any source. The following simply expands on definition of any source to illustrate potential use cases or situations for the FMS. The use cases include situations where water, electricity, heating, or other resources are limited.

These fluid sources can be natural or man-made. These fluid sources can be rigid, collapsible, or pliable. The fluid within the source can be dirty or clean. The fluid can exist in any homogenous or heterogenous condition (for example: varying temperatures). The fluid can exist within and be sourced from any body of water, delivering implement, controlling device, container, or storage. This includes (but is not limited to) the following examples.
bottles that store 0.05 to 3 liters.
buckets or canteens that store. 1 to 50 liters.
hydration packs—such as ones that normally are situated within a backpack.
tanks inside a vehicle or secured to the outside of a vehicle (such as a roof rack).
items with or without a lid, with or without an outlet, with or without a hoseline introducing fluid, or with or without a hoseline dispersing fluid.
Container (such as a pot/kettle) situated on a heating source (such as a camping stove).
Natural body of fluid such as a stream, lake, puddle, or pond
Water grid-Tube, pipe, or fluid line that may or may not be pressurized (such as the fluid lines at home at 60 psi).
Controlling device (such as a valve or pressure reducer) connected to a fluid source or line
Permanent fluid storage tanks such as roof racks on a car or tanks within an RV
Any vessel that includes the output of the FMS or fluid used by the user and intended for recirculation. For example, the fluid source could be a tray collecting grey water that results from taking a shower using the FMS. The grey fluid can be re-drawn by the same FMS, re-filtered, re-heated, re-dispersed through a low-flow device during the same shower and recirculated for a continuous shower.

All or some of the components that make up the FMS can be left in any location relative to the fluid source. This includes but is not limited to submersible left within and/or at the bottom and/or inside of a fluid container, stove, storage, body of water (such as a stream), or tank.
permanently or temporarily secured on a lid of a fluid container, stove, storage, or tank.
submersible left beneath the surface of a naturally occurring or man-made fluid source: such as a stream or lake.
hangs on the edge of a fluid container through a device such as a clamp
permanently or temporarily secured on a universal fitting at an opening of a fluid container, bottle, stove, storage, or tank.
permanently or temporarily secured to a hoseline secured between the outlet of a fluid container, stove, storage, or tank and the pump inlet. an example is a portable hydration pack.
permanently or temporarily secured to a manifold system between a variety of fluid sources, containers, or connecting hoselines.
permanentily or temporarily secured to a mobile vehicle, such as underneath the sink in an rv, behind a panel of a car, or hanging off a car door.
between uses, the entire system can be permanentily or temporarily stored in a carrying case (such as a backpack), in a vehicle (such as a cupholder in a car), in a mobile kitchen (such as under a sink), on top of or underneath a lid, strapped to the side of a fluid container, or left within a fluid container, stove, storage, or tank.

### Alternate Embodiment 1: Cleaning—Mini-Diaphragm Pump & Low Flow Device for Washing or Cleaning with Liquid

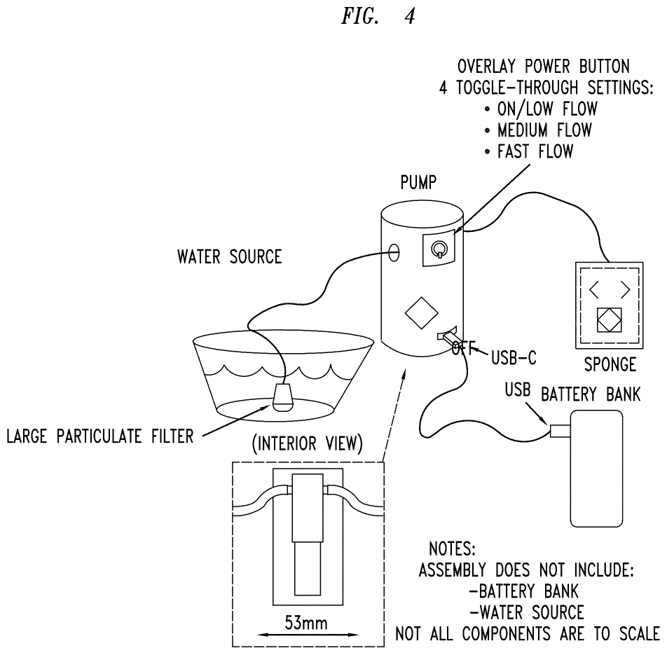

Reference is now made to FIG. 4, which differs slightly from the preferred embodiment of FIGS. 1-2 in that there is a large particulate filter provided at the water source, enabling the water source to be a lake, river etc. as would be found in nature on a backpacking hike.

The embodiment of FIG. 4 is only an example of a basic configuration and is not limited by the elements explained within the drawing nor explanation. In other words, additional filters, fluid bottles, sensors, manual control valves, or other elements listed in the previous sections of this configuration can be added by the user or manufacturer. This explanation simply demonstrates one possible alternate version of the configuration to achieve washing or cleaning with liquid. This configuration demonstrates delivering any fluid and cleaning with said fluid with the smallest amount of energy through a low-flow device.

In this instance, clean fluid is sourced from a bucket. On the proximal end of the configuration, the user placed a large particulate filter into the fluid source. This prevents any damage to the umbrella valves within the pump. The user connects the other end of the hoseline to the inlet of the pump. The user then connects another hoseline to the outlet of the pump. At the distal end of this hoseline exists a low-flow device (in this case the user opts for an interchangeable sponge to shower or clean dishes).

Power is supplied to the pump from a 5V DC source. In this example, the user arrives with a battery bank used to recharge cell phone batteries. The user attaches a USB cable between the battery bank outlet and the power inlet in the pump in order to supply power. The length of cable ideally prevents the user from splashing fluid onto the battery bank.

The pump includes a button for the user to start cleaning with the sponge. The button is an overlay type. Behind the button is overlay ribbon cable that is connected to a PCB (see more details below).

The user begins by pressing this button to turn the pump on. The button can be pressed multiple times to cycle through different flow rates (pre-determined by the manufacturer) as well as turning the pump off.

The pump is a mini-diaphragm pump supported by a brush motor (for example: nominal 6V DC). The voltage supplied to the motor determines the rate of the motor (and shaft) speed (revolutions per second). This determines the rate of plunger action pushing and pulling fluid within each cavity. This determines the overall flow rate coming from the inlet of the pump, through a cavity, through the outlet of the pump, and to the sponge.

In this example, the button is pressed once by the user to achieve a high flow rate. Pressing the button allows the PCB (within the pump) connected to the button to step the 5V DC voltage from the battery bank up to a higher voltage (for example, 6 VDC). This increased voltage is sent to the brush motor within the pump.

The user may decide to alter the flow rate while cleaning. To do this, the user presses the button and toggles from a high to a medium flow rate. Doing so allows the PCB (within the pump) connected to the button to step the 5V DC voltage from the battery bank down to a lower voltage (for example, 2 VDC). This decreased voltage is sent to the brush motor within the pump and slows the speed of the motor (which slows the flow rate of fluid sent by the pump and through the sponge).

To stop operation, the user presses the button on the pump twice more. The first press changes the flow rate to the “low” flow rate (which steps the voltage down even further). The second press changes the flow rate to zero by arriving to the “off” mode (which steps the voltage down to 0 V DC). This discontinues the voltage supplied to the pump and stops the flow rate.

The user disconnects the two hose lines and power cable from the pump. The user stores these items in a small bag for future use and easy portability.

### Alternate Embodiment 2: Filtering, Modifying, and/or Purifying Fluid—Mini-Diaphragm Pump, Filters (or Dispensers), & Controller for Removing Pathogens, Particulates, Bacteria, Protozoa, and Viruses from Liquid (or Adding Substances to Liquid)

The following is a slightly more complicated configuration due to the number of items connected by the user as well as the features provided by the manufacturer. It's an example of a configuration to eliminate unwanted material from dirty fluid or for introducing desired material to clean fluid. This is not limited by the elements explained within the drawing nor explanation. In other words, additional filters, dispensers, fluid bottles, sensors, manual control valves, or other elements listed in the previous paragraphs can be added by the user or manufacturer. This explanation simply demonstrates one possible version of the configuration to clean a fluid and “remove pathogens, particulates, bacteria, protozoa, and viruses from liquid”. This can also remove other unwanted items such as metal, micro-plastics, or other material that makes the taste of the fluid foul.

Although the case may be rare, the following configuration can be used to introduce a controlled amount of material into the fluid. In this instance, the filter would be replaced with a dispenser (or medium) that introduces the controlled amount of material as the fluid traverses the medium. This could include (but is not limited to) essential oils that enhance the aroma of the fluid during a shower. This could also include but is not limited to coagulates or medicines that are dispersed to quickly manage a wound.

This configuration essentially demonstrates modifying the quality any fluid with the smallest amount of energy.

In the following example, we introduce the one possible and challenging situation: taking foul fluid and creating purified drinking fluid without viruses or heavy metals or other solutions. This helps the reader understand that, like Lego components arranged by the user to achieve a specific result, the components of the configuration are additive in nature. More or less components can be added or removed to alter the result.

The following drawing does not include any images of a power source. One can use configuration 1 to imagine the pumps are connected to a source of power. The following drawing does not include any images of a low-flow device. In this instance, the user opts to not connect a low-flow device. The distal end of the hoseline is left open and within a container to collect clean fluid. This container can be replaced with a low-flow device to immediately use the filter's fluid or its intended purpose.

The following drawing introduces the idea of a filter. Filters exist in a variety of forms and achieve different results. This includes but is not limited to:
Ceramic: This is an earthen material (yes, the same kind of stuff your favorite coffee mug is made out of) that has a long life and can be cleaned many times before being replaced. Unfortunately, it can get clogged easily. But on the bright side, scraping it clean is easy. Ceramic filters can also come with a carbon core, which helps to remove chemicals from fluid.
Fiberglass: A material that is more fragile than ceramic, but still effective at eliminating particles.
Hollow Fiber: Made up of hollow U-shaped microtubes, this filter allows fluid through tiny pores and into the core, where pathogens are strained out.
Silica Depth: Using finely grained silica sand, this filter works by having multiple levels of different sized grains, going from largest to finest. It catches different sized particles and organisms as fluid is pushed through its levels of density.
Activated Carbon: Activated carbon can be found in many filters and is used to remove other contaminants like pesticides, heavy metals, smells, and the like. If you're concerned about any of these, be sure to find an option with activated carbon.
UV: Light shines through the fluid to remove finer pathogens.

The pump is the key building block in this configuration. In this example, multiple pumps are purchased and added together by the user in order to overcome the challenging situation. Beyond the delivery of fluid, these pumps perform different activities:
sending dirty fluid through a filter (proximal to distal) to achieve clean drinking fluid
sending clean fluid through a filter (distal to proximal) to backflush and achieve a clean filter
drawing clean fluid through a filter (distal to proximal) to aspirate and achieve a clean filter.

This paragraph is intended to introduce two key points: First, describe the variety of functions these pumps play beyond delivering clean fluid. Second, introducing one important feature that describes, as a whole, this configuration of FMS: the ability to self-clean with minimal amounts of energy.

For illustration, the key in Table A below is provided to describe the configuration:

TABLE A

| | |
|---|---|
| [symbol] | Grey boxes represent pumps. The arrows indicate the direction of flow of the fluid. |
| [symbol] | This symbol is a filter. |
| [symbol] | These symbols are water sources or containers. The different |
| | colors infer varying degrees of foulness (dark brown) to |
| | cleanliness (light blue). |
| [symbol] | These symbols are lines of fluid (via a tube, hose, connector, etc) that |
| [symbol] | are actively traversing from one component to another. The different |
| [symbol] | colors infer varying degrees of foulness (dark brown) to cleanliness |
| [symbol] | (light blue). |
| [symbol] | These symbols are lines of fluid that are connected from one |
| [symbol] | component to another. These lines are not traversing or delivering |
| [symbol] | fluid. The lines only depict a connection between two components |
| [symbol] | (via a tube, hose, connector, etc). The different colors infers varying |
| | degrees of foulness (dark brown) to cleanliness (light blue). |

At a high level (and to simplify the explanation of the configuration), the user must take foul fluid and send it through multiple filters to achieve clean drinking fluid. Multiple filters are required to remove smaller and smaller particulate. These filters, lines, and containers are connected or arranged by the user.

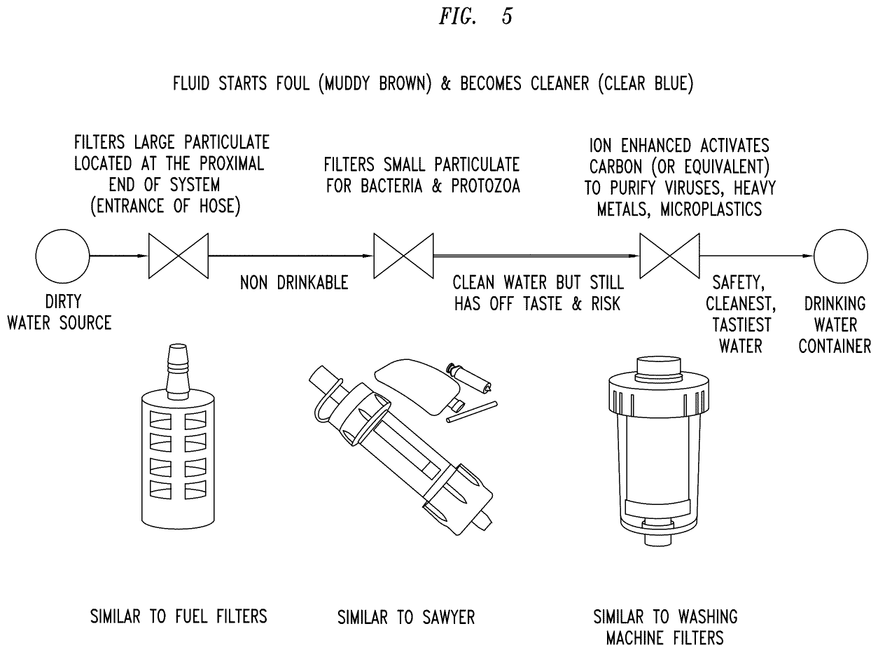

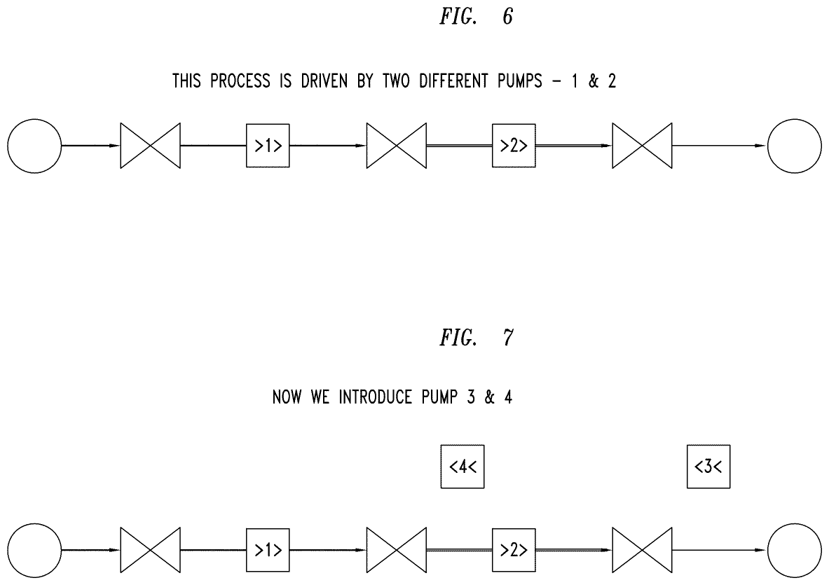

FIG. 5 describes this goal to simplify the conversation. In other words, the user will have all components connected ahead of time (see last image or second-to-last image of this configuration 2) to perform the filter and self-cleaning steps from the beginning of operation.

Sending fluid through each stage of filtration and purification is done through a pump in between each filter. These pumps are intended to draw foul fluid, send it through a filter (distally or proximally of the pump), and out towards the next component. In this configuration of three filters, two pumps are needed. As the arrows in the image suggest, these pumps must be on so that fluid is flowing from the foul fluid source towards the clean fluid container. These are connected by the user.

Reference is made to FIG. 6.

Over a short period of time, the filters become clogged with particulate. Two news pumps are introduced to backflush the filters. (These pump are added only simplify this explanation; the user has already connected these two pumps prior to starting operation).

Reference is made to FIG. 7.

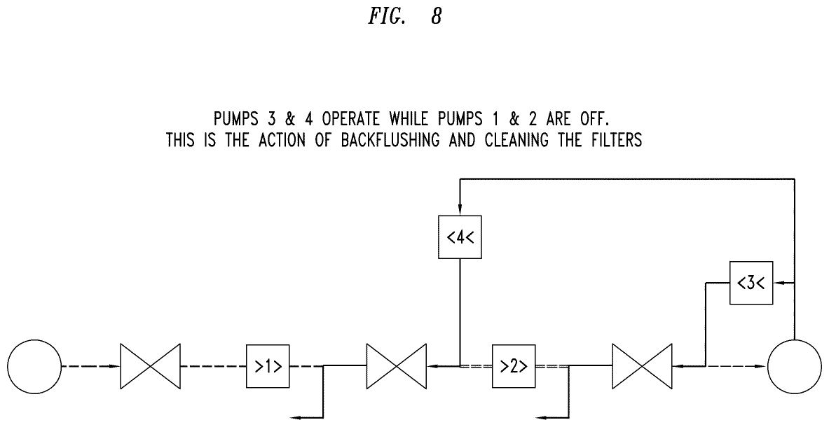

As shown in FIG. 8, the lines for these pumps begin from the drinking fluid source and through the distal end of the filters. Pumps 3 & 4 must be on while pumps 1&2 are off in order to backflush the filters. The resulting fluid from the filters can be dispersed in an open area by means of a solenoid valve dispersing the fluid.

The lines could require connectors and other features that bifurcate the first set of lines established in the images above. Additional one-way or automatic valves (such as solenoid valves) may be required to prevent fluid flowing through an unintended direction and/or present less resistance while pumps 3 and 4 are on. See below for an image of a solenoid valve that could exist before and/or after pumps 1 and 2.

Pumps 5 and 6 may be added as options for aspirating the filters while pumps 3&4 are backflushing. The resulting fluid from the filters can be dispersed in an open area.

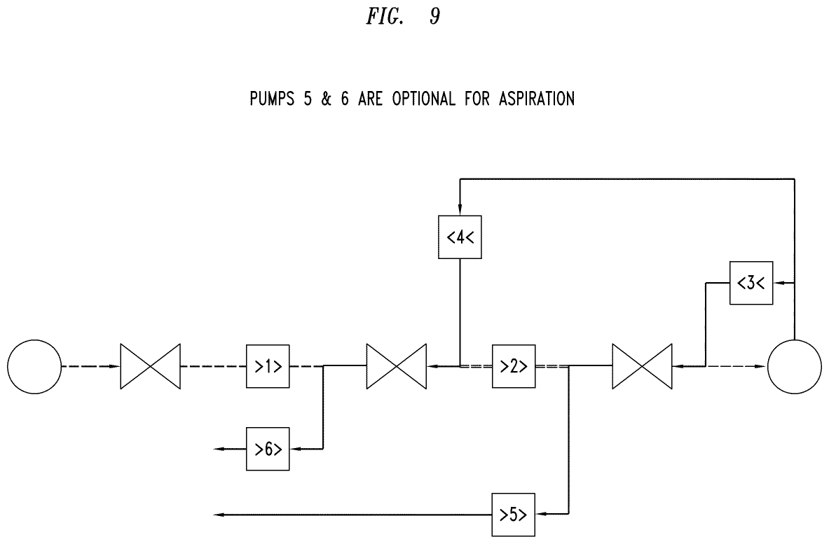

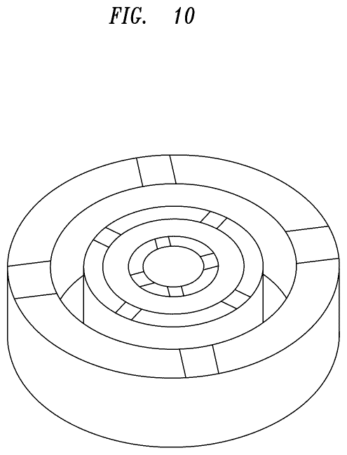

Reference is made to FIG. 9.

We will continue the explanation of the configuration and filtering FMS without pumps 5 and 6 and without aspiration.

The coordination between filtering (pumps 1&2 being on while pumps 3&4 are off) versus backflushing (pumps 1&2 being off while pumps 3&4 are on) is done two ways:

Based on a timeline when filtering is occurring for a period of time (ie: 10 seconds) and backflushing is occurring for shorter period of time (ie: 3 seconds). These two periods will cycle continuously until the user presses a button or depowers the entire FMS to stop filtering.

Based on a condition observed by sensors (for example current or voltage sensor observing the power demanded by the pump's motor, pressure and/or flow rate sensors). Multiple sensors can exist distal and/or proximal of each pump to determine the condition of a proximal or distal filter. Filtering will continue until a sensor determines a filter is becoming clogged with particulate and requires backflushing. This condition will initiate the backflushing condition. Backflushing will continue until a sensor determines a filter is unclogged and free of particulate and ready to begin filtering again.

The coordinated powering of pumps, automatic coordination of solenoid valves, receiving/monitoring information from sensors all require a controller to manage all these activities, information, and components of the FMS.

### The Controller

As explained with reference to the single-pump embodiment in FIG. 3, the controller is the intelligence of the FMS. Multiple pumps, filters, dispensers, heating devices, valves, low-flow device, and sensors may be interconnected to the controller and managed by the controller. The controller will have a user interface, such as knob(s) and button(s) for the user to input into the controller the user's goals for the fluid (such as output fluid temperature of 104 degrees F. and flow rate of 0.3 gpm—see heating configuration below for more information). The controller may also have a display to provide feedback to the user on the progress made towards the desired goal (such as the temperate of fluid within the camping stove) or any other information related to the FMS (such as status of a pump). The controller contains a separate PCB with IC's & firmware that are connected to sensors to receive and manage information. The sensors include, but are not limited to, temperature, fluid level, flow rate, and pressure sensors. The controller uses information captured from the sensors and, through a programmed IC, manages valves, manages pumps, and manages heating devices to achieve the user's fluid goals that are selected on/inputted into the controller. The controller can be connected to a 5V battery source (or include its own power source). The firmware supplies the precise amount of voltage (0 to 24 V dc) to the pumps in order to generate a specific flow rate needed by the controller. This firmware can also control valves to manage the direction of the flow between fluid source(s), pump(s), filters, heating devices, the end user, and/or fluid storage. This firmware can also can (but is not required to) manage gas regulator valves on a stove.

Continuing with the filter configuration above, the user connects four pumps electronically to the controller via USB cables. The controller includes sensors (or are connected to sensors secured within hoselines/couplers between the pumps and filters) before or after the filter to monitor the flowrate or pressure to show the status of the filter. The user presses a button on the controller to begin filtering the foul fluid. The controller activates pumps 1 & 2 to push dirty fluid through each filter and into a fluid storage container holding clean fluid. The controller monitors fluid flow rate (or pressure) distal (or proximal) of each filter to ensure filters are not clogged (or the current or voltage demand of the motors of each pump motor). If the filter becomes clogged with a certain level of particulate, then the controller deactivates pumps 1 & 2 and activates pumps 3&4. These pumps draw clean fluid from the clean fluid source and send the clean fluid through the distal end of the filters. This backflushes the clogged filters for a period of time (4-5 seconds) or until a certain pressure/flow rate is obtained before the controller deactivates pumps 3&4 and activates pumps 1&2 to resume filtering. The controller may continuously and rapidly alter between pumps to ensure the filters remain in a healthy condition and effective level of filtering performance with minimal amounts of energy. This allows the user to consume minimal amounts of energy while the filter remains in an unclogged state or range which requires the least about of energy to push dirty fluid through each filter.

If the controller only observes one filter being clogged (for example—distal of pump 1, proximal of pump 2), it may activate only one pump to backflush (pump 4) in order to conserve power and clean fluid (by not activating pump 3)

The controller continues to do this until the user decides to stop filtering and/or purifying.

In the explanation above, the controller is separate of all pumps, sensors, or filters. If the configuration is simple or if the manufacturer determines it simplify a user's attempt to create an FMS, then any combination of pump(s), filter(s), and/or sensor(s) can exist within a controller. As an example, a controller can exist with a pump together. Obviously, this requires other pumps be connected through additional plugs and USB cables. If more than one “controller+pump” is required by the FMS, then one “controller+pump” will be assigned by the user as a “master controller+pump” with overriding instruction for other “slave controller+pumps” connected within the FMS.

The example above is not limited to these three filters. Additional pumps and filters can be added for additional stages of filtration. This includes but is not limited to UV light filters.

### Alternate Embodiment 3: Heating Fluid—Mini-Diaphragm Pump, Heating Device, & Controller for Heating Liquid

The following is slightly more complicated due to the number of items connected by the user as well as the features provided by the manufacturer. It's an example of a configuration to heat fluid. This is not limited by the elements explained within the drawing nor explanation. In other words, alternative heaters, fluid bottles, sensors, manual control valves, or other elements listed in the previous paragraphs can be added by the user or manufacturer. This explanation simply demonstrates one possible version of the configuration to heat a fluid.

In essence, the objective is to heat fluid with the smallest amount of energy. Unlike the above configurations, this configuration expands on the concept of energy required to achieve the objective. More specifically, in the configurations above, the objective was to use the minimal amount of “battery” energy to power pumps that managed fluid at the smallest flow rate and pressure needed. Much of this is due to the fact that, at the very distal end, significantly less fluid was demanded (both in terms of flow rate and pressure). One could summarize this under the objective to “make the most of every drop of fluid”.

This alternate configuration continues to utilize this advantage and achieve this objective of using as little energy as possible to power pumps and manage fluid. However, we now expand on the topic of energy required to heat fluid by introducing an additional objective of “making the most of every BTU of heat”. This is achieved by introducing new elements that do a better job of transferring heat to fluid (when compared to today's heating products) as well as managing the path of heating fluid within a pot, kettle, or any container that sits above a source of heat. For ease of explanation, we will continue to refer to the container as a pot.

In terms of heat source, it's generally understood that gas lit into a fire is the most effective & reliable source of heat, especially in situations where portability is a priority (such as backpacking). For ease of explanation, this configuration uses the prior art JETBOIL FLASH as an example. This configuration is not limited to gas as a source of heat. While not as effective as today's gas-burning products, this configuration can also use electrical means of heating fluid (i.e., induction heating). The elements introduced are not limited to any type of heat source. In other words, electrically heating fluid can be made more efficient with the following configuration.

Achieving the user's goals requires a new important element that improves the transfer of heat as well as provide a path for fluid flow within the pot of fluid. We now introduce an “intra-pot heat exchanger” (IPHE for short).

As the name suggests, this device is found within the pot. The IPHE is a set of concentric tubes that are centered within each other. The number, thickness, material, or space between each tube can be of any quantity or type to maximize the transfer of heat. However, in all cases, the outer edge of the outermost tube must fit within the pot and have adequate space for the introduction of cold fluid (see more details below). These tubes must also be placed against (or be part of or secured to) the bottom of the pot. The length of each tube can vary as well. In most cases, the length of tubes will remain at or slightly above the height of the pot. The tubes remain concentrically within each other as a result of features that can include but are not limited to spacers between each tube, a plate at one end of tubes that also act as a lid for the pot, and/or a means of permanent fixture (such as a spot weld) on the opposite end of tubes positioned against the bottom/inside surface of the pot. This set of concentric tubes may include additional spacers between the outside of the outer most tube and the inside/sidewall of the pot. These spacers can also act as mediums for transferring heat from the inside/sidewall of the pot and into the outer most tube of the IPHE. These spacers may act as fixtures to press the IPHE against the bottom surface of the pot and/or provide additional support.

As one can imagine, the IPHE is capturing and drawing heat from the inside of the pot and transmitting the heat to the column of water that exists within each concentric tube. This provides a couple of advantages over the traditional pot which relies on water that is near the bottom surface to transfer heat to the water at the top surface of the pot. The IPHE expands the pot's total surface area where the boiling action occurs (vaporization at nucleation sites). This additional surface area induces higher transfers of heat and faster heat times. The IPHE acts as a heating element to draw more heat from the any surface of the pot, which allows the pot to capture more heat from the stove. This induces higher transfers of heat and faster heat times. As one will soon read, the IPHE also forces the fluid to flow through a path inside the pot instead of natural convection. This path includes points where the water must momentarily make contact with the hottest surfaces of the pot and/or the IPHE. This forced pathway induces higher transfers of heat and faster heat times.

A critical feature of the IPHE are the small notches or holes that vary in any size, shape, and position exist in various positions along each tube. We discovered that it's best to have notches exist at the end of the tubes sitting against the inside/bottom surface of the pot. This forces the water to flow against and skim the hottest surface (nucleation sites) of the pot as well as the hottest portion of the IPHE (additional nucleation sites) that is transferring heat from the pot. See image below for an isometric view of three, blue concentric tubes with notches in yellow. The three blue tubes exclude the pot. The view of the image is the bottom side of the IPHE that would sit against the bottom/inside of the pot. Generally speaking, it's best to have the yellow notches equidistant from each other (on the same tube) and furthest away from the notches on a different tube immediately inside or outside the said tube first mentioned within this sentence. The image attempts to illustrate the described distance and shape of these notches. Additional holes can exist along the tube. As a reminder, the image below are notches that exist at the bottom of the IPHE that's pressing against the bottom of the pot. As one will soon read, the path of the fluid starts at the outside of the outermost tube, through the notches on the outermost tube, into the column of gap inside the outermost tube and outside the next smaller tube, then through the notches of this tube, etc., and continues to flow through a notch and column until the fluid finally arrives at the inside of the inner most tube. More detailed description of this flow is found below. This paragraph is intended to describe the basic physical characteristics of the IPHE.

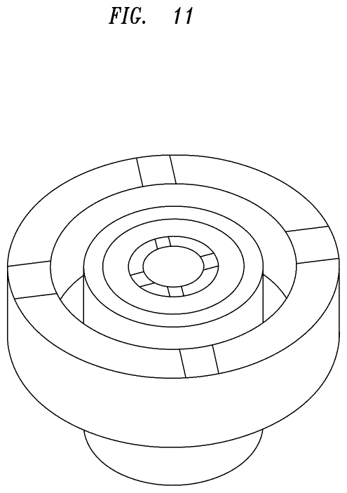

Reference is made to FIG. 10.

In another example of an IPHE, notches exist every other tube as shown in the image below. The tube without notches at the bottom face include holes with a combined surface area larger than the combined surface area of the notches found in the tube surrounding the said tube without notches. More details of how fluid flow through this type of IPHE can be found below. This paragraph is just to illustrate that notches are not required on all tube and fluid can flow towards the center in other paths.

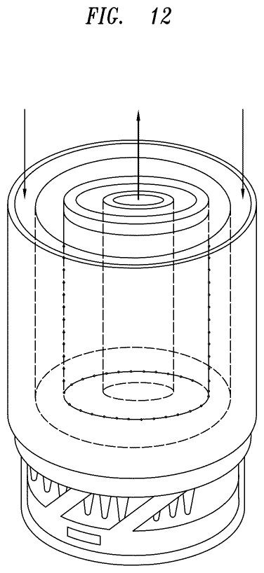

Reference is made to FIG. 11.

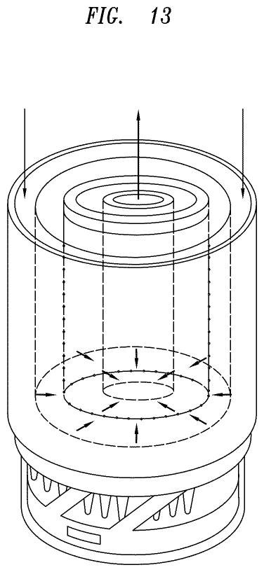

FIG. 12 introduces the IPHE within the JETBOIL FLASH. The dotted lines show the hidden view of the concentric tubes as they extend to and sit against the bottom of the pot. The image below does not include any notches or holes for sake of simplifying the image. It's important to note that the light blue ends of the tubes in the images above makes direct contact with the bottom/inside surface of the pot (more details why this is important is described below). Additional fins or tabs that extend radially from each tube can be used for spot welding or making greater contact with the bottom surface of the pot. Additional fins or tabs can extend radially from the side wall of each tube for spot welding or making greater contact with the side surfaces of the pot or tubes of the IPHE.

The image also describes how fluid is introduced and extracted while the JETBOILand IPHE is heating the fluid. The blue arrows show how fluid is introduced (by pump 1 in the image below of the entire FMS). Fluid can be put into the pot on any place between the outside surface of the IPHE and the inside of the pot. It's preferable that the fluid is introduce sideways and not directly downward so that the fluid continuously, slowly swirls towards the bottom of the pot (instead of getting sent straight downwards towards the bottom). Fluid can be introduced by one fluid line or multiple fluid lines near the top side of the pot.

The red arrow shows how fluid is drawn out of the pot and IPHE via pump 2. The image below does not show a fluid line that continues from the green tube and toward the proximal end of pump 2. Only one line can exist to draw hot fluid out.

As one can imagine, pumps 1 and 2 operate at an equal flow rate to ensure that equal amounts of cold fluid is replacing the drawn-out hot fluid. More details of how this occurs will be found below.

As this point, we introduce the direction of fluid flow within the pot and IPHE. As one can imagine, the introduction of cold fluid at the outside of the pot and the extraction of hot fluid at the inside of the pot requires that the cold fluid traverses each concentric tube from the outside towards the center. The point of traversing is dependent on the location of the notches or holes of each tube. The two images below do not show the notches nor holes, but depict how fluid would flow through each notch assuming the pot had an IPHE similar to the first described above with notches at the end of each tube.

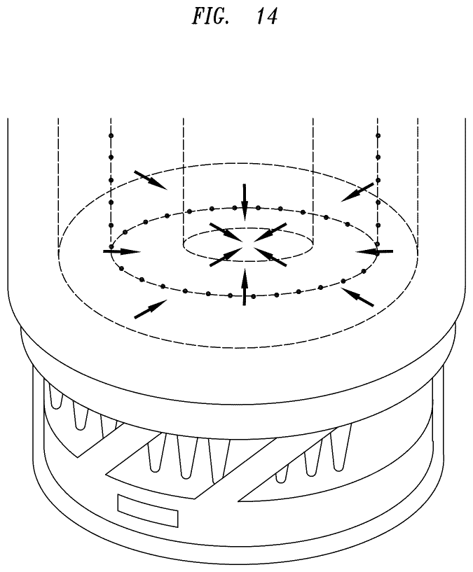

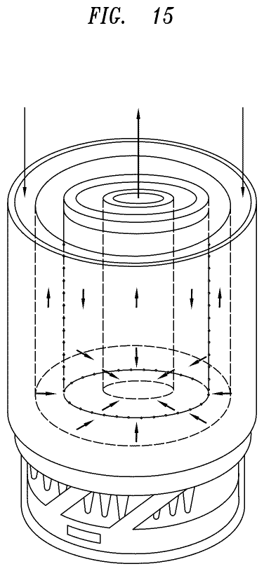

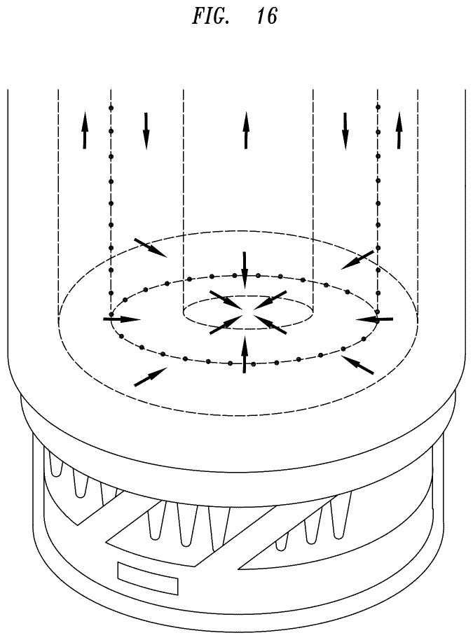

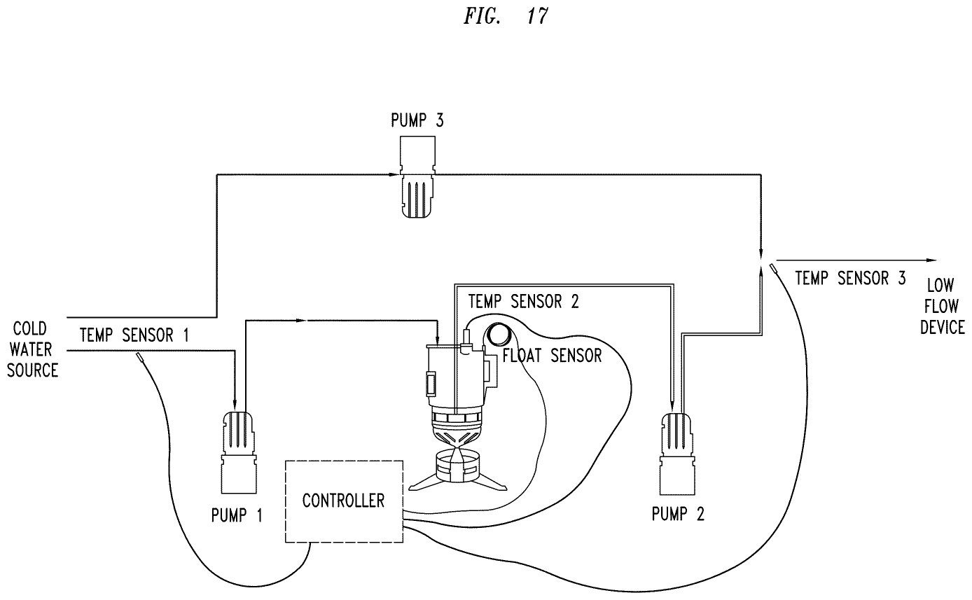

Reference is made to FIGS. 13, 14 15 and 16.

The two images do not show the notches but do show the red dotted holes going through the red tube. The two images below depict how fluid would flow through each notch and hole assuming the pot had an IPHE similar to the second described above with notches at the end the outermost and innermost tubes (blue and green) and holes near the top tube of the red tube without notches.

It's anticipated that, in most cases, the IPHE will be a temporary fixture that can be easily inserted or removed by the user into or from any pot they desire. This can be the case when the user wants to remove the pot from the FMS and use it for other objectives besides heating fluid (such as cooking spaghetti where the entire interior of the pot must be available without obstruction). This also allows the IPHE to be reverse compatible with other stoves and pots in the market. This means of secure can occur a variety of ways: press fitting, magnets, screws through surface of the pot, etc.

The IPHE can also be a permanent fixture within the pot (via processes such as spot welding or CNC machining within a large puck that eventually makes up a solid, one-piece pot along with the IPHE within. Of course, while this level of contact improves the transfer of heat, this also limits the pot for heating fluid with the FMS. We do see this as a serious limitation because, in most cases, campers only use stoves to boil fluid and mix it with dry food. In other words, it's not used for cooking food within the pot itself. Additional features (such as tabs for spot welding, screw holes, etc) at the ends of the tube can be used to secure the IPHE to the pot.

The IPHE may also include features to hold sensors that are later connected to a controller. These sensors are of any type that provide critical information about the fluid heated within the pot. In the illustrated FMS below, we include one float sensor that relay the amount of fluid within the pot. In this example, the float sensor exists near the top of pot and between the outer side of the IPHE and the inside wall of the pot. More details are below for the purpose of this float sensor.

We now begin describing the FMS shown in FIG. 17 . . . . One can use configuration 1 to imagine the pumps are connected to a source of power (or controller). In this instance, the user opts to connect a low-flow device at the distal end of the FMS (to take a hot shower). The following drawing does not include any images of a container or an open end. This low-flow device can be replaced with a container or an open end to store or immediately use hot fluid. In the later case where the end of the distal end is left open, the user may set the controller to deliver boiling fluid through the FMS. For example, the distal end can dispose boiling fluid where the user pours it into a cup of instant coffee or instant ramen noodles. This safer alternative of dispensing boiling water eliminates the need to manage boiling water that could be spilling over the edge of the pot and burning ones hand.

The following TABLE B includes a key of the elements used to depict the entire FMS.

TABLE B

| | |
|---|---|
| [symbol] | Camping Stove |
| [symbol] | Pump |
| [symbol] | Water Line-Depicting varying degrees of |
| [symbol] | temperature of fluid between freezing and boiling |
| [symbol] | |
| [symbol] | Controller |
| [symbol] | Float Sensor |
| [symbol] | Temperature Sensor |

The parts that make up the heating FMS are attached by the user. In this instance, the user must have 3 pumps, one heater, one controller, an IPHE along with float sensor, a temperature sensor contacting fluid distal of a T connector and proximal of the low flow device, another temperature sensor within (or distal to) the cold fluid source, another temperature sensor within (or distal to) the pot, and hose lines and connectors between each of these elements. The user connects these components. The user also connects the sensors and pumps to the controller. In the image below, the pumps are not connected to the controller as a means of simplifying the illustration. One can imagine that the controller is connected to all pumps so that the controller can alter the rate at which each pump is delivering fluid. One can also imagine power is connected to (or within) the controller that later gets delivered to the pumps.

The image below includes lines with arrows of equal shape. This could infer continuous flow of equal rate. However, the reader is forewarned that this inference is not the correct interpretation. The lines can include any level of flow rate (limited to the performance of the pump) at any time. The flow rates within each line may be different from each other. How the flow rates are calculated are described further below. The lines are simply to illustrate fluid flow direction when pumps are in operation.

In this example, we imagine the user seeking a hot shower with a sponge as the low flow device. The cold fluid source is 70 degrees F. To begin operation, the user presses a button on the controller to start powering the FMS. At this stage, all pumps are not operating. The user selects (through a control mechanism on the controller-knob, button, etc) the desired fluid temperate of the shower. In this example, the user desires the fluid coming out of the sponge be at 110 degrees F. At any time during the operation, the user can alter the temperature via this control mechanism and adjust the experience of fluid coming through the sponge.

The user presses another button to initiate this sequence of steps for the FMS to achieve this goal.

The controller first assesses if there is adequate fluid within the pot via float sensor. The controller activates pump 1 at it's highest flow rate to fill the pot by delivering the maximum voltage accepted by the motor of pump 1 through the cable connected between the controller and pump 1. The pump continues to run until the float sensor relays to the controller that the pot is full of fluid. At this point the controller stops pump 1 and instructs the user to begin the stove via a display on the controller. The user starts heating the fluid in the stove by increasing the gas regulator and igniting the gas. The gas regulator can be left at any setting and adjusted at any point of the shower.

Alternatively, the controller may be connected to the stove's igniter and gas regulator in order to automatically ignite the stove and start regulating the gas. In this example, we assume the user manually operates the stove as instructed by the controller.

While the stove is heating the fluid, the controller is assessing the temperature of the cold fluid via sensor 1 and the temperature of the hot fluid via sensor 2. The controller is calculating and communicating to the user its ability to achieve this user's desired goal. It's potential to achieve the goal is likely (but not limited to) to be regularly communicated to the user via a scale of 0 to 10 bars (for ease of comprehension by the user). A display showing 10 bars communicates that the FMS can achieve the user's goal at the highest flow (see step below) with the cold fluid's temperature, the temperature of the hot fluid within the pot, and the desired end goal of the user. A display showing 0 bars communicates that the FMS is not able to achieve the user's goal at the lowest flow rate (0 gpm). The number of bars continuously increase or decrease (and communicates to the user during their shower) relative to the overall capacity of the FMS to deliver the goal considering the following factors (which are accepted and calculated by the controller):
Temperature of the cold fluid at the fluid source
Temperature of the fluid within the pot
The user's desired goal of temperature fluid
The user's desired flow rate delivered through the distal end of the FMS

As the temperature of the fluid within the pot rises, the controller senses this via sensor 2 and displays to the user with more bars increasing on the display. At some point the fluid temperature in the pot will be high enough to achieve the goal when mixed with cold fluid (see steps below). The controller communicates that the shower is ready either through a light or displaying all 10 bars.

At this point, the user turns/presses a control mechanism on the controller (knob, button, etc) to start showering. This control mechanism allows the user to communicate to the controller the desired flow rate (high/medium/low via a button OR any flow rate within a range between 0—maximum gpm obtained via the combination of pump 2&3 via a knob) while achieving the desired fluid temperature. At this point, the controller increases the voltage delivered to pumps 2 & 3 via the power cables connected between the controller and pumps 2&3. These voltages are associated with flow rates memorized by the controller's firmware. This causes cold fluid and hot fluid to merge and mix at the T coupler proximal of temperature sensor 3. Sensor 3 relays back to the controller the resulting temperature of the merged and mixed fluid coming from pumps 2&3. The controller uses this feedback to adjust the voltage of provided to both pumps in order to achieve the temperature goal.

It's important to note that the line distal of the temperature sensor 3 (and proximal of the low flow device) is a combination of the hot fluid delivered by pump 2 (could be up to boiling) and cold fluid of pump 3 (could be down to freezing). The combination is achieved by different flow rates delivered by pump 2 and 3. These flow rates are continuously changes due to changing factors, especially when one considers the continuously changing temperature of hot fluid found within the pot. These different flow rates (that are continuously changing) are achieved by the controller continuously changing the voltage delivered to pumps 2 & 3. Obviously, the voltages delivered to pumps 2&3 can (and usually are) different. In other words, pumps 2&3 deliver hot and cold fluid at different rates (as determined by the controller) with different voltages.

Assuming the user begins the shower, the controller will draw hot fluid via pump 2. As hot fluid is drawn from the pump, cold fluid is introduced to the pot via pump 1. This keeps the pot continuously full as fluid is flowing through the entire path of the IPHE. If the user's desired flow rate is too high (or the rate of heating is too low), then the controller communicates this by decreasing the number of bars. At this point, the user can decrease the desired flow rate or increase the gas delivered through the stove. The controller will then alter the number of bars to communicate that it's capable of achieving the desired flow rate and temperature with the new rate of heat or fluid demand.

In this example, the gas stove and rate of heating is adjusted manually by the user through the gas regulator. However, the gas regulator can also be adjusted automatically by the controller via a cable and any kind of contraption that opens or closes a gas valve dispersing fuel to the burner.

Additional elements on the controller's display can communicate other things to the user: recommended flow rate, resafety features, status of pumps, recommended heat level of the stove, turning the stoves on/off, etc. Additional elements on the controller's panel can introduce other things desired or communicated by the user and into the controller: rated BTU/hr of the stove, amount of gas left in the fuel canister, etc.

As one can imagine, there are multiple variables and conditions that the controller within the FMS must calculate, manage, and communicate. This combination includes (but is not limited to) other situations such as:
1) The fluid source's temperature is higher than the user's desired goal. In this instance, the controller communicates to the user all 10 bars. Pump 3 is the only one that is activated. The controller may request to turn off the stove in order to achieve higher flow rates via pump 2 and 3.
2) The fluid source's temperature is so cold that, relative to the burner's rated BTU/hr, it would be impossible to achieve a desired goal temperature even at the lowest flow rate. In other words, pump 3 will never be activated and the distal end of the FMS is slowly delivering fluid via pump 2. At this point, the controller may need to communicate to (and/or request from) the user that the controller must engage an alternative mode in which pump 1 is not activated while pump 2 is delivering fluid. Of course, the user is made aware that it is limited to the fluid within the pot.
3) The user desires boiling fluid. In this instance, the controller may only turn on pump 2 and not replenish the pot with cold fluid via pump 1. The 10 bars decrease as fluid is drawn to communicate fluid levels in the pot.
4) The user desires a fluid source be brought up to a certain temperature by placing the distal open end of the FMS into the fluid source and recirculating fluid from the source, through the FMS, and back to the source. Once temperature sensor 1 observes that the user's goal of fluid source is achieved, then it stops the FMS and notifies the user.
5) The user desires a fluid container be filled with heated fluid up to a certain level assuming the gas regulator is not changing and no flow rate goal is desired by the user. Then the controller will automatically adjust the flow rate to maximize the BTU/hr delivered by the stove and achieve the desired goal. When the container is full (as communicated by a separate float sensor not shown in the images above), the controller stops the pumps and communicates to the user to turn off the stove.

### ADDITIONAL FEATURES

The three configurations assume the controller or pumps operate with the motors being supplied a continuous amount of voltage for extended periods of time in order to achieve continuous flow rates. The user or controller can also achieve a pulsatile flow rate by momentarily adjusting the voltage on/off or between two different voltages. This provides different types or styles of flow rate including but not limited to pulsatile flow.

What is claimed is:

1. A portable, compact, battery-powered fluid management system comprising:
a plurality of fluid management modules comprising
a continuous flow pump comprising an inlet for drawing in a fluid and pumping the fluid out through an outlet; and
a low-flow fluid delivery device, fluidly coupled to the outlet of the continuous flow pump for receiving the fluid being pumped by the continuous flow pump and delivering the fluid to a user.

2. The system of claim 1 further comprising a bottle stopper fluidly coupled to the inlet, for mating with a fluid bottle that contains the fluid being pumped.

3. The system of claim 2 wherein the bottle stopper comprises a tube passageway into which an inlet tube is inserted for drawing fluid from the fluid bottle to the continuous flow pump.

4. The system of claim 3 wherein the bottle stopper further comprises a one-way air valve or aperture to prevent a vacuum in the fluid bottle while the fluid is drawn from the fluid bottle to the continuous flow pump.

5. The system of claim 4 wherein the bottle stopper press fits within a neck of the fluid bottle.

6. The system of claim 4 wherein the bottle stopper comprises threads to mate with threads on a neck of the fluid bottle.

7. The system of claim 1 wherein the low-flow fluid delivery device comprises a scrub sponge.

8. The system of claim 1 wherein the low-flow fluid delivery device comprises a wet comb.

9. The system of claim 1 wherein the low-flow fluid delivery device comprises a loofah.

10. The system of claim 1 wherein the low-flow fluid delivery device comprises a dog brush.

11. The system of claim 1 wherein the low-flow fluid delivery device comprises a gauze.

12. The system of claim 1 wherein the low-flow fluid delivery device comprises a dressing.

13. The system of claim 1 further comprising a valve fluidly coupled between the outlet of the continuous flow pump and the low-flow fluid delivery device.

14. The system of claim 1 wherein the valve is mechanically operable by a user of the system.

15. The system of claim 1 further comprising
a sensor for measuring a flow rate of the fluid provided to the low-flow fluid delivery device and generating a flow rate signal corresponding to the measured flow rate;
a controller, coupled to the sensor, for receiving the flow rate signal from the sensor and enabling a user to control electronically the operation of the system;
a user interface, coupled to the controller, for
providing feedback to the user regarding the measured flow rate, and
controlling a flow rate of fluid flowing from the continuous flow pump to the low-flow fluid delivery device

16. The system of claim 15 wherein the user interface comprises a potentiometer that adjusts a voltage supplied to the continuous flow pump in order to vary the flow rate of the continuous flow pump.

17. The system of claim 1 wherein the fluid flows from the continuous flow pump to the low-flow fluid delivery device in a substantially continuous non-pulsatile manner.

18. The system of claim 1 wherein the flow rate of fluid is in the range of 0-1 gpm.

19. The system of claim 1 wherein the fluid pressure is in the range of 0-30 psi.

20. A portable, compact, battery-powered fluid management system comprising
a plurality of fluid management modules comprising
a first continuous flow pump comprising an inlet for drawing in a fluid from a cold fluid source and pumping the cold fluid out through an outlet;
a fluid heating module coupled to the outlet of the first pump, for heating the cold fluid provided by the first pump;
a second continuous flow pump comprising an inlet for drawing in the heated fluid output by the fluid heating module and pumping the heated fluid out through an outlet;
a third continuous flow pump comprising an inlet for drawing in a fluid from the cold fluid source and pumping the cold fluid out through an outlet;
a first temperature sensor coupled to the input of the first pump,
a second temperature sensor coupled to the fluid heating module,
a third temperature sensor coupled too the outlets of the second and third pumps, and
a low-flow fluid delivery device, fluidly coupled to the outlet of the second and third pumps, for delivering the fluid to a user; and
a controller for controlling operation of the plurality of fluid management modules.
